(19) United States
(12) Patent Application Publication
(10) Pub. No.: US 2023/0095488 A1
(43) Pub. Date: Mar. 30, 2023

(54) A PROCESS FOR PREPARING A MOLDING, A MOLDING AND USE THEREOF AS METHANE REFORMING CATALYST

(71) Applicant: BASF SE, Ludwigshafen am Rhein (DE)

(72) Inventors: Marcelo Daniel KAUFMAN RECHULSKI, Ludwigshafen am Rhein (DE); Christiane KURETSCHKA, Ludwigshafen am Rhein (DE); Sandra MAGNUS, Ludwigshafen am Rhein (DE); Sabine BORCHERS, Ludwigshafen am Rhein (DE); Juergen AMANN, Ludwigshafen am Rhein (DE)

(21) Appl. No.: 17/795,892

(22) PCT Filed: Jan. 29, 2021
(86) PCT No.: PCT/EP2021/052143

§ 371 Date: Jul. 28, 2022

(30) Foreign Application Priority Data
Jan. 31, 2020 (EP) 20154968.0

(51) Int. Cl. B01J 23/78; C01B 3/40; B01J 6/00; B01J 37/04; B01J 37/00

(52) U.S. Cl. CPC B01J 23/78; C01B 3/40; B01J 6/001; B01J 37/04; B01J 37/0009; C01B 2203/0238; C01B 2203/1058; C01B 2203/1235

(57) ABSTRACT

The present invention relates to a process for preparing a molding comprising a mixed oxide comprising O, Mg, and Ni, the process comprising: —(i) mixing water, a Mg source, a Ni source, and an acid, to obtain a mixture; —(ii) subjecting the mixture obtained from (i) to a shaping process; —(iii) calcining the molding obtained from (ii) in a gas atmosphere having a temperature in the range of from 700 to 1400° C.; wherein the molar ratio of the acid used in (i) to Ni, calculated as elemental Ni, of the Ni source used in (i), acid:Ni, is equal to or higher than 0.001:1. Further, the present invention relates to a molding comprising a mixed oxide comprising O, Mg, and Ni, wherein the mixed oxide comprises a specific crystalline phase NiₓMg_{y}O, wherein the sum of x and y is 1, and wherein y is greater than 0.52. The molding is used for reforming methane to a synthesis gas comprising hydrogen and carbon monoxide.

The present invention relates to a process for preparing a molding comprising a mixed oxide, wherein the mixed oxide comprises O, Mg, and Ni, the molding itself and its use, in particular in the synthesis procedure for the conversion of one or more hydrocarbon to a synthesis gas.

Reforming of hydrocarbons to a synthesis gas is a known catalytic reaction, in which Ni- or Co-containing oxide-based catalysts are used. In general, cost-effective solutions have great economic potential due to the pressure on cost minimization. Thus, the production costs for reforming of hydrocarbons to a synthesis gas, which particularly comprises hydrogen and carbon monoxide, may be reduced by using a more active and selective mixed oxide as heterogeneous oxidic reforming catalyst. A positive effect on the production costs and catalyst efficiency can indirectly be achieved by the stability and longevity of the catalyst.

WO 2013/068905 A1 relates to a process for producing a reforming catalyst and reforming of methane. Further, a catalyst for the reforming of hydrocarbon-comprising compounds and CO₂ to synthesis gas is disclosed. The catalyst is defined as comprising at least nickel-magnesium mixed oxide and magnesium spinel, and optionally aluminum oxide hydroxide, wherein said components are specified by their respective average crystallite size and their molar content, and wherein the catalyst is defined by specific XRD characteristics. In particular, table 7 shows characteristics for example 1 wherein a magnesium nickel mixed oxide having the empirical formula Ni_{0.5}Mg_{0.5}O would be comprised in the sample. Said example was repeated and it is disclosed herein as Comparative Example 1. It has been determined that a magnesium nickel mixed oxide having the empirical formula Ni_{0.52}Mg_{0.48}O is obtained. Thus, the values for magnesium and nickel have been rounded in the prior art.

WO 2013/118078 A1 relates to a hexaaluminate-containing catalyst for reforming of a hydrocarbon and a process for reforming. As regards the catalyst, it is particularly disclosed that it further comprises, besides aluminum and nickel, at least one element from the group consisting of Ba, Sr, and La. According to the examples, it is particularly preferred to prepare the catalyst from the nitrates of nickel and lanthanum.

U.S. Pat. No. 9,259,712 B2 relates to a process for producing a reforming catalyst and the reforming of methane. The catalyst comprises a nickel-magnesium mixed oxide and optionally aluminum oxide hydroxide. The preparation of the catalyst is preferably achieved using nickel nitrate as starting material. Also, additional metals may be included in the preparation, disclosed are inter alia aluminum, lanthanum, and cobalt.

The process for preparation of a mixed oxide serving as a catalytically active species especially for the reforming of hydrocarbons to a synthesis gas is currently either done by precipitation, e. g. from an aqueous solution, or by mixing of the starting materials as solids, i.e. the solid mixing route. Both state-of-the-art routes involve the use of the corresponding water-soluble metal salts as starting materials.

Thus, it was an object to provide a process for preparing a novel molding, in particular to provide a process resulting in a molding having advantageous properties, preferably when used as a catalyst or catalyst component, specifically in a reforming process. Further, it was an object of the present invention to provide a novel molding suitable as catalyst for reforming one or more hydrocarbons, preferably for reforming methane, to a synthesis gas comprising hydrogen and carbon monoxide, which shows a very good longevity and shows an improved catalytic performance, in particular with regard to the conversion of one or more of methane and carbon dioxide. It was a further object of the present invention to provide an improved process for reforming one or more hydrocarbons, preferably for reforming methane, to a synthesis gas comprising hydrogen and carbon monoxide, exhibiting a superior catalytic performance in particular as concerns the conversion of one or more of methane and carbon dioxide.

Surprisingly, it was found that a novel process can be provided in particular by mixing water, a Mg source, a Ni source, and an acid, subjecting the resulting mixture to a shaping process to obtain a molding which is subsequently calcined, wherein a specific molar ratio of the acid used to the Ni of the source is applied for mixing said starting materials. As a result from said process, a novel molding can be obtained exhibiting the above mentioned advantageous characteristics, wherein the molding comprises a mixed oxide comprising Ni, Mg and O, as well as a specific crystalline phase NiₓMg_{y}O, said crystalline phase being particularly Mg rich, thus, having a higher molar content of Mg than Ni. In particular, it has surprisingly been found that a molding can be provided which shows, if used as a catalyst in a reforming process of methane to synthesis gas and if compared to a prior art molding comprising a different mixed oxide comprising Ni, Mg, and O, a significantly increased conversion of methane, and further exhibits excellent life time properties.

Therefore, the present invention relates to a process for preparing a molding comprising a mixed oxide comprising O, Mg, and Ni, the process comprising
(i) mixing water, a Mg source, a Ni source, and an acid, to obtain a mixture;
(ii) subjecting the mixture obtained from (i) to a shaping process, obtaining a molding comprising the mixed oxide;
(iii) calcining the molding obtained from (ii) in a gas atmosphere having a temperature in the range of from 700 to 1400° C.;
   wherein the molar ratio of the acid used in (i) to Ni, calculated as elemental Ni, of the Ni source used in (i), acid:Ni, is equal to or higher than 0.001:1.

It is preferred that the molar ratio of the acid used in (i) to Ni, calculated as elemental Ni, of the Ni source used in (i), acid:Ni, is in the range of from 0.002:1 to 100:1, more preferably in the range of from 0.003:1 to 50:1, more preferably in the range of from 0.004:1 to 30:1, more preferably in the range of from 0.125:1 to 25:1, more preferably in the range of from 0.15:1 to 22:1, more preferably in the range of from 0.2:1 to 20:1, more preferably in the range of from 0.5:1 to 15:1, more preferably in the range of from 1:1 to 10:1, more preferably in the range of from 2:1 to 9:1, more preferably in the range of from 3:1 to 8:1, more preferably in the range of from 4:1 to 7:1, more preferably in the range of from 5:1 to 6:1.

It is preferred that the weight ratio of Ni, calculated as elemental Ni, of the Ni source used in (i), relative to Mg, calculated as elemental Mg, of the Mg source used in (i), Ni:Mg, is in the range of from 0.1:1 to 5:1, more preferably in the range of from 0.3:1 to 2.5:1, more preferably in the range of from 0.5:1 to 2:1, more preferably in the range of from 1:1 to 1.5:1, more preferably in the range of from 1.1:1 to 1.4:1.

No particular restriction applies with regard to the Mg source. It is preferred that the Mg source comprises, preferably consists of, one or more of magnesium carbonate, magnesium chloride, magnesium citrate, magnesium hydroxide, magnesium oxide, hydrotalcite and an aluminum magnesium hydroxy carbonate, more preferably an aluminum magnesium hydroxy carbonate, more preferably an aluminum magnesium hydroxy carbonate having the empirical formula Mg₂ₓAl₂(OH)₄ₓ₊₄CO₃.nH₂O, wherein x is in the range of from 1 to 5, preferably in the range of from 2 to 4, and wherein n is in the range of from to 1 to 7, preferably in the range of from 3 to 5.

It is preferred that the Mg source has a BET specific surface area in the range of from 200 to 350 m²/g, more preferably in the range of from 225 to 320 m²/g, more preferably in the range of from 250 to 310 m²/g, determined according to Reference Example 1.

It is preferred that the Mg source has a loose bulk density in the range of from 0.10 to 0.80 g/ml, more preferably in the range of from 0.25 to 0.65 g/ml, more preferably in the range of from 0.3 to 0.6 g/ml.

It is preferred that the Mg source has a pore volume in the range of from 0.20 to 0.90 g/ml, preferably in the range of from 0.40 to 0.70 g/ml, more preferably in the range of from 0.45 to 0.60 g/ml, preferably determined after activation under air for 3 h at 550° C.

It is preferred that the Mg source is in particulate form. In the case where the Mg source is in particulate form, it is preferred that from 77 to 97 weight-%, more preferably from 82 to 94 weight-%, more preferably from 85 to 91 weight-%, of the particles of the Mg source have a maximum diameter smaller than 90 micrometer, preferably determined by laser diffraction spectroscopy.

Further in the case where the Mg source is in particulate form, it is preferred that from 32 to 70 weight-%, more preferably from 38 to 64 weight-%, more preferably from 41 to 61 weight-%, of the particles of the Mg source have a maximum diameter smaller than 45 micrometer, preferably determined by laser diffraction spectroscopy.

Further in the case where the Mg source is in particulate form, it is preferred that from 12 to 50 weight-%, more preferably from 16 to 46 weight-%, more preferably from 19 to 43 weight-%, of the particles of the Mg source have a maximum diameter smaller than 25 micrometer, preferably determined by laser diffraction spectroscopy.

It is preferred that from 0 to 0.01 weight-%, preferably from 0 to 0.001 weight-%, more preferably from 0 to 0.0001 weight-%, of the Mg source consists of a nitrate. More preferably, the Mg source is essentially free of nitrates. Further, the Mg source is more preferably not magnesium nitrate.

No particular restriction applies with regard to the Ni source. It is preferred that the Ni source comprises, more preferably consists of, one or more of elemental Ni, nickel carbonate, nickel nitrate, nickel formate, nickel acetate, nickel chloride, nickel hydroxide, nickel nitrite, and nickel oxide, more preferably one or more of nickel carbonate, nickel nitrate, and nickel oxide, more preferably one or more of nickel carbonate and nickel nitrate.

According to a first alternative, it is particularly preferred that the Ni source comprises, preferably consists of, nickel nitrate. Further, it is preferred that the nickel nitrate is provided in an aqueous solution.

According to a second alternative, it is preferred that the Ni source comprises a first Ni source and a second Ni source, wherein the first Ni source is different to the second Ni source.

In the case where the Ni source comprises a first Ni source and a second Ni source, it is preferred that the first Ni source is selected from the group consisting of elemental Ni, nickel nitrate, nickel nitrite, nickel carbonate, nickel chloride, nickel bromide, nickel iodide, nickel acetate, nickel octanoate, nickel acetylacetonate, nickel ethanolate, nickel methanolate. It is particularly preferred that the first Ni source is elemental Ni or nickel nitrate, more preferably nickel nitrate.

Further in the case where the Ni source comprises a first Ni source and a second Ni source, it is preferred that the second Ni source is selected from the group consisting of elemental Ni, nickel nitrate, nickel nitrite, nickel carbonate, nickel chloride, nickel bromide, nickel iodide, nickel acetate, nickel octanoate, nickel acetylacetonate, nickel ethanolate, nickel methanolate. It is particularly preferred that the second Ni source is elemental Ni or nickel carbonate, preferably nickel carbonate.

Further in the case where the Ni source comprises a first Ni source and a second Ni source, it is preferred that the weight ratio of the first Ni source to the second Ni source is in the range of from 1:1000 to 1000:1, more preferably in the range of from 1:100 to 100:1, more preferably in the range of from 1:90 to 90:1, more preferably in the range of from 1:80 to 80:1, more preferably in the range of from 1:75 to 75:1, more preferably in the range of from 1:71 to 71:1, more preferably in the range of from 1:70 to 70:1.

It is particularly preferred that the Ni source comprises nickel carbonate and nickel nitrate. In the case where the Ni source comprises nickel carbonate and nickel nitrate, it is preferred that the weight ratio of nickel carbonate to nickel nitrate, NiCO₃:Ni(NO₃)₂, of the Ni source, is in the range of from 0.001:1 to 1:0.001, more preferably in the range of from 0.35:1 to 1:0.001, more preferably in the range of from 0.9:1 to 0.001, more preferably in the range of from 2:1 to 1:0.001, more preferably in the range of from 3:1 to 1:0.001.

As an alternative, it is preferred that the Ni source comprises, preferably consists of, nickel carbonate, wherein at least a portion, more preferably from 10 to 100 weight-%, more preferably from 50 to 100 weight-%, more preferably from 90 to 100 weight-%, of the nickel carbonate is prepared by precipitating nickel carbonate using carbonate ions from an aqueous solution comprising nickel ions.

It is preferred that the weight ratio of the sum of the weight of the Mg source used in (i) and the weight of the Ni source used in (i) to the sum of the weight of the acid used in (i) and the weight of the water used in (i), is in the range of from 0.1:1 to 1:0.1, more preferably in the range of from 0.5:1 to 1:0.5, more preferably in the range of from 0.9:1 to 1:0.9.

It is preferred that from 95 to 100 weight-%, more preferably from 98 to 100 weight-%, more preferably from 99 to 100 weight-%, more preferably from 99.5 to 100 weight-%, more preferably from 99.9 to 100 weight-%, of the mixture obtained from (i) consist of the Mg source, the Ni source, the acid, and the water.

It is preferred that in (i) a source of a metal M is further admixed, wherein M is selected from the group consisting of aluminum, gallium, indium, silicon, germanium, tin, titanium and zirconium, more preferably from the group consisting of aluminum, silicon and titanium, wherein more preferably in (i) a source of Al is further admixed.

In the case where in (i) a source of M is further admixed, it is preferred that M is Al. In the case where a source of Al is further admixed in (i), it is preferred that the source of Al comprises, preferably consists of, an oxidic aluminum compound, more preferably one or more of AlOOH (boehmite), Al₂O₃, Al(OH)₃, hydrotalcite and an aluminum magnesium hydroxy carbonate, wherein the aluminum magnesium hydroxy carbonate preferably has the empirical formula Mg₂ₓAl₂(OH)₄ₓ₊₄CO₃.nH₂O, wherein x is in the range of from 1 to 5, preferably in the range of from 2 to 4, and wherein n is in the range of from 1 to 7, more preferably in the range of from 3 to 5, wherein the source of Al more preferably comprises, more preferably consists of, one or more of an aluminum magnesium hydroxy carbonate and AlOOH (boehmite), wherein the aluminum magnesium hydroxy carbonate more preferably has the empirical formula Mg₂ₓAl₂(OH)₄ₓ₊₄CO₃.nH₂O, wherein x is in the range of from 1 to 5, preferably in the range of from 2 to 4, and wherein n is in the range of from 1 to 7, more preferably in the range of from 3 to 5.

In the case where in (i) a source of a metal M is further admixed, wherein M is Al, it is preferred that the source of Al comprises AlOOH (boehmite) and that the source of Mg comprises an aluminum magnesium hydroxy carbonate, wherein the aluminum magnesium hydroxy carbonate preferably has the empirical formula Mg₂ₓAl₂(OH)₄ₓ₊₄CO₃.nH₂O, wherein x is in the range of from 1 to 5, preferably in the range of from 2 to 4, and wherein n is in the range of from 1 to 7, more preferably in the range of from 3 to 5. In the case where the source of Al comprises AlOOH (boehmite) and the source of Mg comprises an aluminum magnesium hydroxy carbonate, it is preferred that the molar ratio of AlOOH to the aluminum magnesium hydroxy carbonate is in the range of from 6:1 to 12:1, more preferably in the range of from 8.5:1 to 9.5:1, more preferably in the range of from 8.9:1 to 9.1:1.

Further in the case where in (i) a source of a metal M is further admixed, it is preferred that from 0 to 0.01 weight-%, more preferably from 0 to 0.001 weight-%, more preferably from 0 to 0.0001 weight-%, of the source of a metal M, preferably of the source of Al, consists of a nitrate. It is particularly preferred that the source of a metal M is essentially free of nitrates. Further, it is particularly preferred that the source of a metal M is not a nitrate of the metal M.

Further in the case where in (i) a source of a metal M is further admixed, it is preferred that the weight ratio of the sum of the weight of the Mg source used in (i), the weight of the Ni source used in (i) and the weight of the source of a metal M further admixed in (i), to the sum of the weight of the acid used in (i) and the weight of the water used in (i), is in the range of from 0.1:1 to 1:0.1, more preferably in the range of from 0.5:1 to 1:0.5, more preferably in the range of from 0.9:1 to 1:0.9.

Further in the case where in (i) a source of a metal M is further admixed, it is preferred that from 95 to 100 weight-%, more preferably from 98 to 100 weight-%, more preferably from 99 to 100 weight-%, more preferably from 99.5 to 100 weight-%, more preferably from 99.9 to 100 weight %, of the mixture obtained from (i) consist of the Mg source, the Ni source, the acid, the water, and the source of a metal M.

Further in the case where in (i) a source of a metal M is further admixed, it is preferred that the acid used in (i) comprises, preferably consists of, one or more of an organic acid and an inorganic acid, wherein the organic acid more preferably is one or more of formic acid, acetic acid, propionic acid, oxalic acid, and tartaric acid, wherein the inorganic acid preferably is one or more of hydrochloric acid and nitric acid, wherein the acid more preferably comprises, preferably consists of, formic acid and nitric acid.

It is preferred that the acid used in (i) is provided in an aqueous solution, wherein the aqueous solution comprising the acid more preferably has a concentration of the acid in the range of from 30 to 70 weight-%, more preferably in the range of from 40 to 60 weight-%, more preferably in the range of from 45 to 55 weight-% based on the total weight of the solution.

It is preferred that mixing in (i) comprises kneading.

According to a first alternative, it is preferred that mixing in (i) comprises
(i.a) mixing the Mg source, the Ni source, and optionally water, obtaining a pre-mixture;
(i.b) mixing the acid and water to the pre-mixture obtained from (i.a).

According to a second alternative, it is preferred that mixing in (i) comprises
(i.a′) mixing water, the Ni source, and the acid, obtaining a pre-mixture;
(i.b′) mixing the Mg source to the pre-mixture obtained from (i.a′).

It is preferred that mixing according to one or more of (i.a), (i.b), (i.a′), and (i.b′), preferably of (i.a), (i.b), (i.a′), and (i.b′), comprises kneading.

According to a first alternative, it is preferred that subjecting the mixture obtained from (i) to a shaping process according to (ii) comprises, more preferably consists of, extruding the mixture obtained from (i).

In the case where subjecting the mixture obtained from (i) to a shaping process according to (ii) comprises extruding the mixture obtained from (i), it is preferred that the mixture obtained from (i) is extruded to strands having a diameter in the range of from 2.5 to 4.5 mm, more preferably in the range of from 3.2 to 3.8 mm, more preferably in the range of from 3.4 to 3.6 mm.

According to a second alternative, it is preferred that subjecting the mixture obtained from (i) to a shaping process according to (ii) comprises, more preferably consists of, tableting the mixture obtained from (i).

The process of the present invention may comprise further process steps. It is preferred that (ii) comprises
(ii.a) subjecting the mixture obtained according to (i) to a shaping process, obtaining a molding comprising the mixed oxide;
(ii.b) drying the molding obtained from (ii.a) in a gas atmosphere having a temperature in the range of from 70 to 150° C.

In the case where (ii) comprises (ii.a) and (ii.b), it is preferred that the gas atmosphere in (ii.b) has a temperature in the range of from 100 to 140° C., more preferably in the range of from 110 to 130° C., more preferably in the range of from 115 to 125° C.

Further in the case where (ii) comprises (ii.a) and (ii.b), it is preferred that the gas atmosphere in (ii.b) comprises oxygen and optionally nitrogen, wherein the gas atmosphere more preferably is air or lean air.

Further in the case where (ii) comprises (ii.a) and (ii.b), it is preferred that drying in (ii.b) is performed for a duration in the range of from 1 to 36 h, more preferably in the range of from 5 to 25 h, more preferably in the range of from 13 to 19 h, more preferably in the range of from 15 to 17 h.

It is preferred that the gas atmosphere in (iii) has a temperature in the range of from 800 to 1300° C., more preferably in the range of from 900 to 1250° C., more preferably in the range of from 925 to 1075° C.

It is preferred that the gas atmosphere in (iii) comprises oxygen and optionally nitrogen, wherein the gas atmosphere more preferably is air or lean air.

It is preferred that the calcination in (iii) is performed for a duration in the range of from 0.5 to 20 h, more preferably in the range of from 1 to 15 h, more preferably in the range of from 2 to 10 h, more preferably in the range of from 3 to 5 h.

Further, the present invention relates to a molding comprising a mixed oxide comprising O, Mg, and Ni, obtainable or obtained by a process according to any one of the embodiments disclosed herein.

Yet further, the present invention relates to a molding comprising a mixed oxide, wherein the mixed oxide comprises O, Mg, and Ni, more preferably a molding obtainable or obtained by a process according to any one of the embodiments disclosed herein, wherein the mixed oxide comprises a crystalline phase NiₓMg_{y}O, wherein the sum of x and y is 1, and wherein y is greater than 0.52.

It is preferred that y is equal or greater than 0.53, wherein y more preferably is in the range of from 0.53 to 0.85, more preferably in the range of from 0.53 to 0.75, more preferably in the range of from 0.54 to 0.70.

It is preferred that the mixed oxide further comprises a crystalline phase NiₐMg_{b}O, wherein the sum of a and b is 1, and

wherein a is equal or greater than 0.70, more preferably in the range of from 0.71 to 0.99, more preferably in the range of from 0.72 to 0.95, more preferably in the range of from 0.73 to 0.90, more preferably in the range of from 0.74 to 0.85, more preferably in the range of from 0.75 to 0.84, more preferably in the range of from 0.76 to 0.83, more preferably in the range of from 0.77 to 0.82, more preferably in the range of from 0.78 to 0.81,
wherein x is not equal to a.

It is preferred that in the mixed oxide the molar ratio of nickel to magnesium, Ni:Mg, each calculated as elemental Ni and Mg respectively, is in the range of from 0.20:1 to 0.75:1, more preferably in the range of from 0.40:1 to 0.74:1, more preferably in the range of from 0.43:1 to 0.56:1, more preferably in the range of from 0.45:1 to 0.52:1, more preferably in the range of from 0.48:1 to 0.49:1.

It is preferred that from 10 to 20 weight-%, more preferably from 14 to 18 weight-%, more preferably from 15 to 17 weight-%, more preferably from 15 to 16 weight-%, of the mixed oxide consist of Ni, calculated as elemental Ni.

It is preferred that from 5 to 20 weight-%, more preferably from 11 to 15 weight-%, more preferably from 12.5 to 13.5 weight-%, of the mixed oxide consist of Mg, calculated as elemental Mg.

It is preferred that the mixed oxide further comprises a metal M, wherein M is selected from the group consisting of Al, Ga, In, Si, Ge, Sn, Ti and Zr, more preferably from the group consisting of Al, Si and Ti, wherein the metal M more preferably is Al.

In the case where the mixed oxide further comprises a metal M, it is preferred that in the mixed oxide the molar ratio of nickel to the metal M, Ni:M, each calculated as elemental metal M and Ni respectively, is in the range of from 0.05:1 to 0.70:1, more preferably in the range of from 0.10:1 to 0.50:1, more preferably in the range of from 0.20:1 to 0.30:1, more preferably in the range of from 0.23:1 to 0.25:1.

Further in the case where the mixed oxide further comprises a metal M, it is preferred that in the mixed oxide the molar ratio Mg:M of magnesium to the metal M, each calculated as elemental Mg and metal M respectively, is in the range of from 0.20:1 to 0.80:1, more preferably in the range of from 0.40:1 to 0.60:1, more preferably in the range of from 0.47:1 to 0.53:1, more preferably in the range of from 0.49:1 to 0.51:1.

Further in the case where the mixed oxide further comprises a metal M, it is preferred that from 20 to 40 weight-%, more preferably from 27 to 31 weight-%, more preferably from 28 to 29.5 weight-%, of the mixed oxide consist of the metal M, calculated as elemental metal M.

Further in the case where the mixed oxide further comprises a metal M, it is preferred that M is Al, and that the mixed oxide further comprises a crystalline phase MgAl₂O₄.

In the case where the mixed oxide further comprises a crystalline phase MgAl₂O₄, it is preferred that the average particle size of the crystals of the crystalline phase MgAl₂O₄ is in the range of from 1 to 70 nm, more preferably in the range of from 3 to 40 nm, more preferably in the range of from 6 to 25 nm, as determined according to Reference Example 2.

It is preferred that the mixed oxide comprises from 0 to 1 weight-%, more preferably from 0.001 to 0.1 weight-%, more preferably from 0.01 to 0.1 weight-%, of a crystalline phase Al₂O₃. It is particularly preferred that the mixed oxide is essentially free of a crystalline phase Al₂O₃. Further, it is particularly preferred that the mixed oxide does not comprise a crystalline phase Al₂O₃.

It is preferred that the mixed oxide comprises from 0 to 1 weight-%, more preferably from 0.001 to 0.1 weight-%, more preferably from 0.01 to 0.1 weight-%, of a crystalline phase NiAl₂O₄ It is particularly preferred that the mixed oxide is essentially free of a crystalline phase NiAl₂O₄. Further, it is particularly preferred that the mixed oxide does not comprise a crystalline phase NiAl₂O₄.

It is preferred that the mixed oxide comprises from 0 to 1 weight-%, more preferably from 0.001 to 0.1 weight-%, more preferably from 0.01 to 0.1 weight-%, of a crystalline phase NiO. It is particularly preferred that the mixed oxide is essentially free of a crystalline phase NiO. Further, it is particularly preferred that the mixed oxide does not comprise a crystalline phase NiO.

It is preferred that the mixed oxide comprises from 0 to 1 weight-%, more preferably from 0.001 to 0.1 weight-%, more preferably from 0.01 to 0.1 weight-%, of a crystalline phase MgO. It is particularly preferred that the mixed oxide is essentially free of a crystalline phase MgO. Further it is particularly preferred that the mixed oxide does not comprise a crystalline phase MgO.

It is preferred that the molding comprises from 0 to 1 weight-%, more preferably from 0.001 to 0.1 weight-%, more preferably from 0.01 to 0.1 weight-%, of a crystalline phase Al₂O₃. It is particularly preferred that the molding is essentially free of a crystalline phase Al₂O₃. Further, it is particularly preferred that the molding does not comprise a crystalline phase Al₂O₃.

It is preferred that the molding comprises from 0 to 1 weight-%, more preferably from 0.001 to 0.1 weight-%, more preferably from 0.01 to 0.1 weight-%, of a crystalline phase NiAl₂O₄. It is particularly preferred that the molding is essentially free of a crystalline phase NiAl₂O₄. Further, it is particularly preferred that the molding does not comprise a crystalline phase NiAl₂O₄.

It is preferred that the molding comprises from 0 to 1 weight-%, more preferably from 0.001 to 0.1 weight-%, more preferably from 0.01 to 0.1 weight-%, of a crystalline phase NiO. It is particularly preferred that the molding is essentially free of a crystalline phase NiO. Further, it is particularly preferred that the molding does not comprise a crystalline phase NiO.

It is preferred that the molding comprises from 0 to 1 weight-%, more preferably from 0.001 to 0.1 weight-%, more preferably from 0.01 to 0.1 weight-%, of a crystalline phase MgO. It is particularly preferred that the molding is essentially free of a crystalline phase MgO. Further, it is particularly preferred that the molding does not comprise a crystalline phase MgO.

It is preferred that from 99 to 100 weight-%, more preferably from 99.5 to 100 weight-%, more preferably from 99.9 to 100 weight-% of the mixed oxide consist of O, Mg, Ni, optionally a metal M as defined in any one of the embodiments disclosed herein, and optionally H.

It is preferred that the mixed oxide comprises the crystalline phase NiₓMg_{y}O, in an amount in the range of from 1 to 50 weight-%, more preferably in the range of from 5 to 40 weight-%, more preferably in the range of from 10 to 30 weight-%, based on the total weight of the mixed oxide.

It is preferred that the mixed oxide comprises a crystalline phase NiₐMg_{b}O, in an amount of equal to or less than 20 weight-%, more preferably equal to or less than 15 weight-%, more preferably equal to or less than 10 weight-%, based on the total weight of the mixed oxide.

It is preferred that the lattice parameter a of the crystalline phase NiₓMg_{y}O is in the range of from 4.18 to 4.22 Angstrom, more preferably in the range of from 4.190 to 4.204, more preferably in the range of from 4.1940 to 4.1997, wherein the lattice parameter a is preferably determined according to Reference Example 2.

It is preferred that the mixed oxide exhibits a X-ray diffraction spectrum, determined as described in Reference Example 2, wherein the X-ray diffraction spectrum comprises a first peak having a maximum in the range of from 43.00 to 43.30° 2theta, wherein d according to the Bragg equation more preferably is in the range of from 2.08 to 2.10 Angstrom, and a second peak having a maximum in the range of from 44.63 to 45.03° 2theta, wherein d more preferably is in the range of from 2.01 to 2.03 Angstrom.

In the case where the mixed oxide exhibits a X-ray diffraction spectrum comprising a first peak and a second peak, it is preferred that the intensity of the maximum of the first peak, calculated as peak height in arbitrary units, is equal to or less than the intensity of the maximum of the second peak, calculated as peak height in arbitrary units, wherein the ratio of the intensity of the maximum of the first peak to the intensity of the maximum of the second peak is in the range of from 0.3:1 to 1:1, more preferably in the range of from 0.5:1 to 0.99:1, more preferably in the range of from 0.6:1 to 0.97:1, more preferably in the range of from 0.7:1 to 0.92:1.

It is preferred that the molding comprises carbon, more preferably in an amount of equal to or less than 5 g per kg of the molding, more preferably equal to or less than 3 g per kg, more preferably equal to or less than 2 g per kg.

It is preferred that the mixed oxide exhibits a temperature programmed reduction profile, wherein the temperature programmed reduction profile comprises a first peak having a maximum in the range of from 700 to 840° C., more preferably in the range of from 750 to 825° C., wherein the temperature programmed reduction profile preferably is determined according to Reference Example 3.

It is preferred that the mixed oxide exhibits a temperature programmed reduction profile, wherein the temperature programmed reduction profile comprises a second peak having a maximum in the range of from 850 to 900° C., more preferably in the range of from 855 to 880° C., wherein the temperature programmed reduction profile preferably is determined according to Reference Example 3.

It is preferred that the mixed oxide exhibits a temperature programmed reduction profile, wherein the temperature programmed reduction profile comprises a third peak having a maximum in the range of from 300 to 600° C., more preferably in the range of from 350 to 550° C., wherein the temperature programmed reduction profile preferably is determined according to Reference Example 3.

It is preferred that the mixed oxide exhibits a temperature programmed reduction profile, wherein the temperature programmed reduction profile shows a total hydrogen consumption in the range of from 10 to 1000 micromol H₂/g mixed oxide, more preferably in the range of from 30 to 800 micromol H₂/g mixed oxide, more preferably in the range of from 50 to 700 micromol H₂/g mixed oxide, at a temperature below 600° C., more preferably in the range of from 0 to 600° C., more preferably in the range of from 50 to 600° C., wherein the temperature programmed reduction profile preferably is determined according to Reference Example 3.

It is preferred that the mixed oxide exhibits a temperature programmed reduction profile, wherein the temperature programmed reduction profile shows a total hydrogen consumption in the range of from 1300 to 3000 micromol H₂/g mixed oxide, more preferably in the range of from 1500 to 2800 micromol H₂/g mixed oxide, more preferably in the range of from 1700 to 2600 micromol H₂/g mixed oxide, at a temperature above 600° C., more preferably in the range of from 600 to 1000° C., more preferably in the range of from 600 to 950° C., wherein the temperature programmed reduction profile preferably is determined according to Reference Example 3.

It is preferred that from 99 to 100 weight-%, more preferably from 99.5 to 100 weight-%, more preferably from 99.9 to 100 weight-% of the molding consist of the mixed oxide.

It is preferred that the molding is not calcined.

It is preferred that the molding is a tablet, more preferably a tablet having a four-hole cross-section, more preferably being a tablet having a four-hole cross-section and having four flutes, more preferably being a tablet having a four-hole cross-section having a diameter in the range of from 13 to 19 mm, more preferably in the range of from 14 to 18 mm, more preferably in the range of from 15 to 17 mm, and a height in the range of from 9 to 11 mm, more preferably in the range of from 9.5 to 10.5 mm, more preferably in the range of from 9.7 to 10 mm.

Yet further, the present invention relates to a process for preparing a re-shaped molding, more preferably for preparing a re-shaped molding of the molding comprising a mixed oxide according to any one of the embodiments disclosed herein, wherein the process comprises
(a) preferably calcining a molding obtained from (iii) of a process according to any one of the embodiments disclosed herein, in a gas atmosphere having a temperature in the range of from 350 to 550° C., more preferably in the range of from 400 to 500° C., more preferably in the range of from 425 to 475° C.;
(b) more preferably crushing the molding obtained from (a) to particles having an average particle size in the range of from 0.1 to 0.9 mm, more preferably in the range of from 0.2 to 0.8 mm, determined according to Reference Example 2;
(c) more preferably preparing a mixture comprising one or more binders and the molding obtained from (b);
(d) subjecting a molding obtained from (iii) of a process according to any one of the embodiments disclosed herein, preferably the molding obtained from (a), more preferably the molding obtained from (b), more preferably the molding obtained from (c) to a re-shaping process;
(e) calcining the molding obtained from (d) in a gas atmosphere having a temperature in the range of from 800 to 1300° C., obtaining a re-shaped molding.

It is preferred that the re-shaped molding obtained from (e) has a shape different to the shape of the molding obtained from (iii).

It is preferred that the gas atmosphere in (e) has a temperature in the range of from 850 to 1150° C., more preferably in the range of from 900 to 1100° C., more preferably in the range of from 950 to 1050° C.

It is preferred that the gas atmosphere in (e) comprises oxygen and optionally nitrogen, wherein the gas atmosphere more preferably is air or lean air.

It is preferred that the calcination in (e) is performed for 0.1 to 5 h, more preferably for 0.5 to 3 h, more preferably for 0.75 to 1.5 h, more preferably for 0.9 to 1.1 h.

It is preferred that the calcination in (e) is performed for 1 to 10 h, more preferably for 3 to 5 h, more preferably for 3.5 to 4.5 h, more preferably for 3.9 to 4.1 h.

It is preferred that the gas atmosphere in (a) comprises oxygen and optionally nitrogen, wherein the gas atmosphere more preferably is air or lean air.

It is preferred that crushing according to (b) comprises, preferably consists of, milling.

It is preferred that subjecting a molding obtained from (iii), preferably the molding obtained from (a), more preferably the molding obtained from (b), more preferably the molding obtained from (c), to a re-shaping process in (d) comprises, preferably consists of, extruding or tableting, more preferably tableting.

It is preferred that subjecting a molding obtained from (iii), preferably the molding obtained from (a), more preferably the molding obtained from (b), more preferably the molding obtained from (c), to a re-shaping process in (d) comprises, preferably consists of, tableting the molding to tablets having a cylindrical shape.

In the case where subjecting a molding obtained from (iii), preferably the molding obtained from (a), more preferably the molding obtained from (b), and more preferably the molding obtained from (c), to a re-shaping process in (d) comprises tableting the molding to tablets having a cylindrical shape, it is preferred that the tablets having a cylindrical shape have a diameter in the range of from 10 to 22 mm, more preferably in the range of from 14 to 19 mm, more preferably in the range of from 16 to 17 mm.

Further in the case where subjecting a molding obtained from (iii), preferably the molding obtained from (a), more preferably the molding obtained from (b), and more preferably the molding obtained from (c), to a re-shaping process in (d) comprises tableting the molding to tablets having a cylindrical shape, it is preferred that the tablets having a cylindrical shape have a height in the range of from 5 to 15 mm, more preferably in the range of from 8 to 12 mm, more preferably in the range of from 9 to 11 mm.

It is preferred that in the mixture prepared in (c), the weight of the one or more binders calculated with respect to the total weight of the mixture is in the range of from 0.5 to 10 weight-%, more preferably in the range of from 1 to 9 weight-%, more preferably in the range of from 2 to 4 weight-%.

It is preferred that the one or more binders in (c) comprise one or more of graphite, a polysaccharide, a sugar alcohol and a synthetic polymer, more preferably one or more of graphite and a polysaccharide.

In the case where the one or more binders in (c) comprise one or more of graphite, a polysaccharide, a sugar alcohol and a synthetic polymer, it is preferred that the polysaccharide is one or more of cellulose, a modified cellulose and a starch. It is particularly preferred that the cellulose is a microcrystalline cellulose. Further, it is particularly preferred that the modified cellulose is one or more of a cellulose ether, a hydroxypropyl cellulose (HCP) and a hydroxypropyl methylcellulose (HPMC).

Further in the case where the one or more binders in (c) comprise one or more of graphite, a polysaccharide, a sugar alcohol and a synthetic polymer, it is preferred that the sugar alcohol is one or more of sorbitol and mannitol.

Further in the case where the one or more binders in (c) comprise one or more of graphite, a polysaccharide, a sugar alcohol and a synthetic polymer, it is preferred that the synthetic polymer is one or more of polyethylene glycol (PEG) and polyvinylpyrrolidone (PVP).

Yet further, the present invention relates to a re-shaped molding comprising a mixed oxide comprising O, Mg, and Ni, obtainable or obtained by a process according to any one of the embodiments disclosed herein.

Yet further, the present invention relates to a use of a molding according to any one of the embodiments disclosed herein or of a re-shaped molding according to any one of the embodiments disclosed herein as a catalytically active material, as a catalyst component or as a catalyst, preferably for reforming one or more hydrocarbons, wherein the one or more hydrocarbons preferably is selected from the group consisting of methane, ethane, propane, butane, and a mixture of two or more thereof, wherein the one or more hydrocarbons more preferably is methane, to a synthesis gas comprising hydrogen and carbon monoxide, preferably in the presence of one or more of carbon dioxide and steam.

Yet further, the present invention relates to a method for reforming one or more hydrocarbons, preferably for reforming methane, to a synthesis gas comprising hydrogen and carbon monoxide, the method comprising
(a) providing a reactor comprising a reaction zone which comprises the molding of any one of the embodiments disclosed herein or of a re-shaped molding according to any one of the embodiments disclosed herein;
(b) passing a reactant gas stream into the reaction zone obtained from (a), wherein the reactant gas stream passed into the reaction zone comprises the one or more hydrocarbons, carbon dioxide, and water; subjecting said reactant gas stream to reforming conditions in said reaction zone; and removing a product stream from said reaction zone, said product stream comprising hydrogen and carbon monoxide.

In the context of the present invention, a crystalline phase NiₓMg_{y}O as well as a crystalline phase NiₐMg_{b}O is defined, wherein x, y, a, and b can be a real number, wherein the sum of x and y is 1 and wherein the sum of a and b is 1. Further, a crystalline phase NiₓMg_{y}O is different to a crystalline phase NiₐMg_{b}O according to the present invention when x is not equal to a, and y is not equal to b. For example, the crystalline phase NiₓMg_{y}O, where x is 0.75 and y is 0.25 is different to a crystalline phase NiₐMg_{b}O, where a is 0.20 and b is 0.80.

According to the present invention, a prepared material was analyzed by X-ray diffraction, preferably determined as described in Reference Example 2. In the thus determined X-ray diffraction spectrum of a material, the characteristic peaks were observed relative to a 2theta angle. For evaluating a diffraction spectrum, a maximum of a respective peak can be determined. For a peak having a maximum the intensity given in arbitrary units can be taken as an intensity of a peak.

A molding obtained from a process for preparing a molding according to the present invention has a particular shape. In the context of the present invention, the term “shape” relates to a three-dimensional geometry of an entity such as a molding. Thus, a shape of a molding can be defined by one or more of its physical dimensions, for example by one or more of its length, its width and its height, and also by one or more of its diameter and its cross-section. Further, a re-shaped molding obtained from a process for preparing a re-shaped molding according to the present invention typically has a different shape than a “non” re-shaped molding. In the context of the present invention, the term “the re-shaped molding obtained from (e) has a shape different to the shape of the molding obtained from (iii)” is to be understood in the sense that the shape of the re-shaped molding differs in at least one physical dimension from the shape of the molding obtained from (iii).

The unit bar(abs) refers to an absolute pressure wherein 1 bar equals 10⁵ Pa.

The present invention is further illustrated by the following set of embodiments and combinations of embodiments resulting from the dependencies and back-references as indicated. In particular, it is noted that in each instance where a range of embodiments is mentioned, for example in the context of a term such as “The process of any one of embodiments 1 to 4”, every embodiment in this range is meant to be explicitly disclosed for the skilled person, i.e. the wording of this term is to be understood by the skilled person as being synonymous to “The process of any one of embodiments 1, 2, 3, and 4”. Further, it is explicitly noted that the following set of embodiments is not the set of claims determining the extent of protection, but represents a suitably structured part of the description directed to general and preferred aspects of the present invention.
1. A process for preparing a molding comprising a mixed oxide comprising O, Mg, and Ni, the process comprising
   (i) mixing water, a Mg source, a Ni source, and an acid, to obtain a mixture;
   (ii) subjecting the mixture obtained from (i) to a shaping process, obtaining a molding comprising the mixed oxide;
   (iii) calcining the molding obtained from (ii) in a gas atmosphere having a temperature in the range of from 700 to 1400° C.;
   wherein the molar ratio of the acid used in (i) to Ni, calculated as elemental Ni, of the Ni source used in (i), acid:Ni, is equal to or higher than 0.001:1.
2. The process of embodiment 1, wherein the molar ratio of the acid used in (i) to Ni, calculated as elemental Ni, of the Ni source used in (i), acid:Ni, is in the range of from 0.002:1 to 100:1, preferably in the range of from 0.003:1 to 50:1, more preferably in the range of from 0.004:1 to 30:1, more preferably in the range of from 0.125:1 to 25:1, more preferably in the range of from 0.15:1 to 22:1, more preferably in the range of from 0.2:1 to 20:1, more preferably in the range of from 0.5:1 to 15:1, more preferably in the range of from 1:1 to 10:1, more preferably in the range of from 2:1 to 9:1, more preferably in the range of from 3:1 to 8:1, more preferably in the range of from 4:1 to 7:1, more preferably in the range of from 5:1 to 6:1.
3. The process of embodiment 1 or 2, wherein the weight ratio of Ni, calculated as elemental Ni, of the Ni source used in (i), relative to Mg, calculated as elemental Mg, of the Mg source used in (i), Ni:Mg, is in the range of from 0.1:1 to 5:1, preferably in the range of from 0.3:1 to 2.5:1, more preferably in the range of from 0.5:1 to 2:1, more preferably in the range of from 1:1 to 1.5:1, more preferably in the range of from 1.1:1 to 1.4:1.
4. The process of any one of embodiments 1 to 3, wherein the Mg source comprises, preferably consists of, one or more of magnesium carbonate, magnesium chloride, magnesium citrate, magnesium hydroxide, magnesium oxide, hydrotalcite and an aluminum magnesium hydroxy carbonate, more preferably an aluminum magnesium hydroxy carbonate, more preferably an aluminum magnesium hydroxy carbonate having the empirical formula Mg₂ₓAl₂(OH)₄ₓ₊₄CO₃.nH₂O, wherein x is in the range of from 1 to 5, preferably in the range of from 2 to 4, and wherein n is in the range of from to 1 to 7, preferably in the range of from 3 to 5.
5. The process of any one of embodiments 1 to 4, wherein the Mg source has a BET specific surface area in the range of from 200 to 350 m²/g, preferably in the range of from 225 to 320 m²/g, more preferably in the range of from 250 to 310 m²/g, determined according to Reference Example 1.
6. The process of any one of embodiments 1 or 5, wherein the Mg source has a loose bulk density in the range of from 0.10 to 0.80 g/ml, preferably in the range of from 0.25 to 0.65 g/ml, more preferably in the range of from 0.3 to 0.6 g/ml.
7. The process of any one of embodiments 1 to 6, wherein the Mg source has a pore volume in the range of from 0.20 to 0.90 g/ml, preferably in the range of from 0.40 to 0.70 g/ml, more preferably in the range of from 0.45 to 0.60 g/ml, preferably determined after activation under air for 3 h at 550° C.
8. The process of any one of embodiments 1 to 7, wherein the Mg source is in particulate form, wherein from 77 to 97 weight-%, preferably from 82 to 94 weight-%, more preferably from 85 to 91 weight-%, of the particles of the Mg source have a maximum diameter smaller than 90 micrometer, preferably determined by laser diffraction spectroscopy.
9. The process of any one of embodiments 1 to 8, wherein the Mg source is in particulate form, wherein from 32 to 70 weight-%, preferably from 38 to 64 weight-%, more preferably from 41 to 61 weight-%, of the particles of the Mg source have a maximum diameter smaller than 45 micrometer, preferably determined by laser diffraction spectroscopy.
10. The process of any one of embodiments 1 to 9, wherein the Mg source is in particulate form, wherein from 12 to 50 weight-%, preferably from 16 to 46 weight-%, more preferably from 19 to 43 weight-%, of the particles of the Mg source have a maximum diameter smaller than 25 micrometer, preferably determined by laser diffraction spectroscopy.
11. The process of any one of embodiments 1 to 10, wherein from 0 to 0.01 weight-%, preferably from 0 to 0.001 weight-%, more preferably from 0 to 0.0001 weight-%, of the Mg source consists of a nitrate, wherein more preferably the Mg source is essentially free of nitrates, wherein more preferably the Mg source is not magnesium nitrate.
12. The process of any one of embodiments 1 to 11, wherein the Ni source comprises, preferably consists of, one or more of elemental Ni, nickel carbonate, nickel nitrate, nickel formate, nickel acetate, nickel chloride, nickel hydroxide, nickel nitrite, and nickel oxide, preferably one or more of nickel carbonate, nickel nitrate, and nickel oxide, more preferably one or more of nickel carbonate and nickel nitrate.
13. The process of embodiment 12, wherein the Ni source comprises, preferably consists of, nickel nitrate, wherein the nickel nitrate is provided in an aqueous solution.
14. The process of any one of embodiments 1 to 13, wherein the Ni source comprises a first Ni source and a second Ni source, wherein the first Ni source is different to the second Ni source.
15. The process of embodiment 14, wherein the first Ni source is selected from the group consisting of elemental Ni, nickel nitrate, nickel nitrite, nickel carbonate, nickel chloride, nickel bromide, nickel iodide, nickel acetate, nickel octanoate, nickel acetylacetonate, nickel ethanolate, nickel methanolate.
16. The process of embodiment 14 or 15, wherein the first Ni source is elemental Ni or nickel nitrate, preferably nickel nitrate.
17. The process of any one of embodiments 14 to 16, wherein the second Ni source is selected from the group consisting of elemental Ni, nickel nitrate, nickel nitrite, nickel carbonate, nickel chloride, nickel bromide, nickel iodide, nickel acetate, nickel octanoate, nickel acetylacetonate, nickel ethanolate, nickel methanolate.
18. The process of any one of embodiments 14 to 17, wherein the second Ni source is elemental Ni or nickel carbonate, preferably nickel carbonate.
19. The process of any one of embodiments 14 to 18, wherein the weight ratio of the first Ni source to the second Ni source is in the range of from 1:1000 to 1000:1, preferably in the range of from 1:100 to 100:1, more preferably in the range of from 1:90 to 90:1, more preferably in the range of from 1:80 to 80:1, more preferably in the range of from 1:75 to 75:1, more preferably in the range of from 1:71 to 71:1, more preferably in the range of from 1:70 to 70:1.
20. The process of any one of embodiments 1 to 19, wherein the Ni source comprises nickel carbonate and nickel nitrate, wherein the weight ratio of nickel carbonate to nickel nitrate, NiCO₃:Ni(NO₃)₂, of the Ni source, is in the range of from 0.001:1 to 1:0.001, preferably in the range of from 0.35:1 to 1:0.001, more preferably in the range of from 0.9:1 to 0.001, more preferably in the range of from 2:1 to 1:0.001, more preferably in the range of from 3:1 to 1:0.001.
21. The process of any one of embodiments 1 to 20, wherein the Ni source comprises, preferably consists of, nickel carbonate, wherein at least a portion, preferably from 10 to 100 weight-%, more preferably from 50 to 100 weight-%, more preferably from 90 to 100 weight-%, of the nickel carbonate is prepared by precipitating nickel carbonate using carbonate ions from an aqueous solution comprising nickel ions.
22. The process of any one of embodiments 1 to 21, wherein the weight ratio of the sum of the weight of the Mg source used in (i) and the weight of the Ni source used in (i) to the sum of the weight of the acid used in (i) and the weight of the water used in (i), is in the range of from 0.1:1 to 1:0.1, preferably in the range of from 0.5:1 to 1:0.5, more preferably in the range of from 0.9:1 to 1:0.9.
23. The process of any one of embodiments 1 to 22, wherein from 95 to 100 weight-%, preferably from 98 to 100 weight-%, more preferably from 99 to 100 weight-%, more preferably from 99.5 to 100 weight-%, more preferably from 99.9 to 100 weight-%, of the mixture obtained from (i) consist of the Mg source, the Ni source, the acid, and the water.
24. The process of any one of embodiments 1 to 22, wherein in (i) a source of a metal M is further admixed, wherein M is selected from the group consisting of aluminum, gallium, indium, silicon, germanium, tin, titanium and zirconium, preferably from the group consisting of aluminum, silicon and titanium, wherein more preferably in (i) a source of Al is further admixed.
25. The process of embodiment 24, wherein M is aluminum, and wherein the source of Al comprises, preferably consists of, an oxidic aluminum compound, preferably one or more of AlOOH (boehmite), Al₂O₃, Al(OH)₃, hydrotalcite and an aluminum magnesium hydroxy carbonate, wherein the aluminum magnesium hydroxy carbonate preferably has the empirical formula Mg₂ₓAl₂(OH)₄ₓ₊₄CO₃.nH₂O, wherein x is in the range of from 1 to 5, preferably in the range of from 2 to 4, and wherein n is in the range of from 1 to 7, more preferably in the range of from 3 to 5, wherein the source of Al more preferably comprises, more preferably consists of, one or more of an aluminum magnesium hydroxy carbonate and AlOOH (boehmite), wherein the aluminum magnesium hydroxy carbonate more preferably has the empirical formula Mg₂ₓAl₂(OH)₄ₓ₊₄CO₃.nH₂O, wherein x is in the range of from 1 to 5, preferably in the range of from 2 to 4, and wherein n is in the range of from 1 to 7, more preferably in the range of from 3 to 5.
26. The process of embodiment 24 or 25, wherein in (i) a source of a metal M is further admixed, wherein M is Al, wherein the source of Al comprises AlOOH (boehmite) and wherein the source of Mg comprises an aluminum magnesium hydroxy carbonate, wherein the aluminum magnesium hydroxy carbonate preferably has the empirical formula Mg₂ₓAl₂(OH)₄ₓ₊₄CO₃.nH₂O, wherein x is in the range of from 1 to 5, preferably in the range of from 2 to 4, and wherein n is in the range of from 1 to 7, more preferably in the range of from 3 to 5, wherein the molar ratio of AlOOH to the aluminum magnesium hydroxy carbonate is in the range of from 6:1 to 12:1, preferably in the range of from 8.5:1 to 9.5:1, more preferably in the range of from 8.9:1 to 9.1:1.
27. The process of any one of embodiments 24 to 26, wherein from 0 to 0.01 weight-%, preferably from 0 to 0.001 weight-%, more preferably from 0 to 0.0001 weight-%, of the source of a metal M, preferably of the source of Al, consists of a nitrate, wherein more preferably the source of a metal M is essentially free of nitrates, wherein more preferably the source of a metal M is not a nitrate of the metal M.
28. The process of any one of embodiments 24 to 27, wherein the weight ratio of the sum of the weight of the Mg source used in (i), the weight of the Ni source used in (i) and the weight of the source of a metal M further admixed in (i), to the sum of the weight of the acid used in (i) and the weight of the water used in (i), is in the range of from 0.1:1 to 1:0.1, preferably in the range of from 0.5:1 to 1:0.5, more preferably in the range of from 0.9:1 to 1:0.9.
29. The process of any one of embodiments 24 to 28, wherein from 95 to 100 weight-%, preferably from 98 to 100 weight-%, more preferably from 99 to 100 weight-%, more preferably from 99.5 to 100 weight-%, more preferably from 99.9 to 100 weight-%, of the mixture obtained from (i) consist of the Mg source, the Ni source, the acid, the water, and the source of a metal M.
30. The process of any one of embodiments 1 to 29, wherein the acid used in (i) comprises, preferably consists of, one or more of an organic acid and an inorganic acid, wherein the organic acid preferably is one or more of formic acid, acetic acid, propionic acid, oxalic acid, and tartaric acid, wherein the inorganic acid preferably is one or more of hydrochloric acid and nitric acid, wherein the acid more preferably comprises, preferably consists of, formic acid and nitric acid.
31. The process of any one of embodiments 1 to 30, wherein the acid used in (i) is provided in an aqueous solution, wherein the aqueous solution comprising the acid preferably has a concentration of the acid in the range of from 30 to 70 weight-%, more preferably in the range of from 40 to 60 weight-%, more preferably in the range of from 45 to 55 weight-% based on the total weight of the solution.
32. The process of any one of embodiments 1 to 31, wherein mixing in (i) comprises kneading.
33. The process of any one of embodiments 1 to 32, wherein mixing in (i) comprises
   (i.a) mixing the Mg source, the Ni source, and optionally water, obtaining a pre-mixture;
   (i.b) mixing the acid and water to the pre-mixture obtained from (i.a).
34. The process of any one of embodiments 1 to 32, wherein mixing in (i) comprises
   (i.a′) mixing water, the Ni source, and the acid, obtaining a pre-mixture;
   (i.b′) mixing the Mg source to the pre-mixture obtained from (i.a′).
35. The process of embodiment 34, wherein mixing according to one or more of (i.a), (i.b), (i.a′), and (i.b′), preferably of (i.a), (i.b), (i.a′), and (i.b′), comprises kneading.
36. The process of any one of embodiments 1 to 35, wherein subjecting the mixture obtained from (i) to a shaping process according to (ii) comprises, preferably consists of, extruding the mixture obtained from (i).
37. The process of embodiment 36, wherein subjecting the mixture obtained from (i) to a shaping process according to (ii) comprises, preferably consists of, extruding the mixture obtained from (i), to strands having a diameter in the range of from 2.5 to 4.5 mm, preferably in the range of from 3.2 to 3.8 mm, more preferably in the range of from 3.4 to 3.6 mm.
38. The process of any one of embodiments 1 to 35, wherein subjecting the mixture obtained from (i) to a shaping process according to (ii) comprises, preferably consists of, tableting the mixture obtained from (i).
39. The process of any one of embodiments 1 to 38, wherein (ii) comprises
   (ii.a) subjecting the mixture obtained according to (i) to a shaping process, obtaining a molding comprising the mixed oxide;
   (ii.b) drying the molding obtained from (ii.a) in a gas atmosphere having a temperature in the range of from 70 to 150° C.
40. The process of embodiment 39, wherein the gas atmosphere in (ii.b) has a temperature in the range of from 100 to 140° C., preferably in the range of from 110 to 130° C., more preferably in the range of from 115 to 125° C.
41. The process of embodiment 39 or 40, wherein the gas atmosphere in (ii.b) comprises oxygen and optionally nitrogen, wherein the gas atmosphere preferably is air or lean air.
42. The process of any one of embodiments 39 to 41, wherein drying in (ii.b) is performed for a duration in the range of from 1 to 36 h, preferably in the range of from 5 to 25 h, more preferably in the range of from 13 to 19 h, more preferably in the range of from 15 to 17 h.
43. The process of any one of embodiments 1 to 42, wherein the gas atmosphere in (iii) has a temperature in the range of from 800 to 1300° C., preferably in the range of from 900 to 1250° C., more preferably in the range of from 925 to 1075° C.
44. The process of any one of embodiments 1 to 43, wherein the gas atmosphere in (iii) comprises oxygen and optionally nitrogen, wherein the gas atmosphere preferably is air or lean air.
45. The process of any one of embodiments 1 to 44, wherein the calcination in (iii) is performed for a duration in the range of from 0.5 to 20 h, preferably in the range of from 1 to 15 h, more preferably in the range of from 2 to 10 h, more preferably in the range of from 3 to 5 h.
46. A molding comprising a mixed oxide comprising O, Mg, and Ni, obtainable or obtained by a process according to any one of embodiments 1 to 45.
47. A molding comprising a mixed oxide, wherein the mixed oxide comprises O, Mg, and Ni, preferably a molding obtainable or obtained by a process according to any one of embodiments 1 to 45,
   wherein the mixed oxide comprises a crystalline phase NiₓMg_{y}O,
   wherein the sum of x and y is 1, and wherein y is greater than 0.52.
48. The molding of embodiment 47, wherein y is equal or greater than 0.53, wherein y preferably is in the range of from 0.53 to 0.85, more preferably in the range of from 0.53 to 0.75, more preferably in the range of from 0.54 to 0.70.
49. The molding of embodiment 47 or 48, wherein the mixed oxide further comprises a crystalline phase NiₐMg_{b}O, wherein the sum of a and b is 1, and
   wherein a is equal or greater than 0.70, preferably in the range of from 0.71 to 0.99, more preferably in the range of from 0.72 to 0.95, more preferably in the range of from 0.73 to 0.90, more preferably in the range of from 0.74 to 0.85, more preferably in the range of from 0.75 to 0.84, more preferably in the range of from 0.76 to 0.83, more preferably in the range of from 0.77 to 0.82, more preferably in the range of from 0.78 to 0.81, wherein x is not equal to a.
50. The molding of any one of embodiments 47 to 49, wherein in the mixed oxide the molar ratio of nickel to magnesium, Ni:Mg, each calculated as elemental Ni and Mg respectively, is in the range of from 0.20:1 to 0.75:1, preferably in the range of from 0.40:1 to 0.74:1, more preferably in the range of from 0.43:1 to 0.56:1, more preferably in the range of from 0.45:1 to 0.52:1, more preferably in the range of from 0.48:1 to 0.49:1.
51. The molding of any one of embodiments 47 to 50, wherein from 10 to 20 weight-%, preferably from 14 to 18 weight-%, more preferably from 15 to 17 weight-%, more preferably from 15 to 16 weight-%, of the mixed oxide consist of Ni, calculated as elemental Ni.
52. The molding of any one of embodiments 47 to 51, wherein from 5 to 20 weight-%, preferably from 11 to 15 weight-%, more preferably from 12.5 to 13.5 weight-%, of the mixed oxide consist of Mg, calculated as elemental Mg.
53. The molding of any one of embodiments 47 to 52, wherein the mixed oxide further comprises a metal M, wherein M is selected from the group consisting of Al, Ga, In, Si, Ge, Sn, Ti and Zr, preferably from the group consisting of Al, Si and Ti, wherein the metal M more preferably is Al.
54. The molding of embodiment 53, wherein in the mixed oxide the molar ratio of nickel to the metal M, Ni:M, each calculated as elemental metal M and Ni respectively, is in the range of from 0.05:1 to 0.70:1, preferably in the range of from 0.10:1 to 0.50:1, more preferably in the range of from 0.20:1 to 0.30:1, more preferably in the range of from 0.23:1 to 0.25:1.
55. The molding of embodiment 53 or 54, wherein in the mixed oxide the molar ratio Mg:M of magnesium to the metal M, each calculated as elemental Mg and metal M respectively, is in the range of from 0.20:1 to 0.80:1, preferably in the range of from 0.40:1 to 0.60:1, more preferably in the range of from 0.47:1 to 0.53:1, more preferably in the range of from 0.49:1 to 0.51:1.
56. The molding of any one of embodiments 53 to 55, wherein from 20 to 40 weight-%, preferably from 27 to 31 weight-%, more preferably from 28 to 29.5 weight-%, of the mixed oxide consist of the metal M, calculated as elemental metal M.
57. The molding of any one of embodiments 53 to 56, wherein M is Al, and wherein the mixed oxide further comprises a crystalline phase MgAl₂O₄.
58. The molding of embodiment 57, wherein the average particle size of the crystals of the crystalline phase MgAl₂O₄ is in the range of from 1 to 70 nm, preferably in the range of from 3 to 40 nm, more preferably in the range of from 6 to 25 nm, as determined according to Reference Example 2.
59. The molding of any one of embodiments 47 to 58, wherein the mixed oxide comprises from 0 to 1 weight-%, preferably from 0.001 to 0.1 weight-%, more preferably from 0.01 to 0.1 weight-%, of a crystalline phase Al₂O₃, wherein the mixed oxide more preferably is essentially free of a crystalline phase Al₂O₃, wherein the mixed oxide more preferably does not comprise a crystalline phase Al₂O₃.
60. The molding of any one of embodiments 47 to 59, wherein the mixed oxide comprises from 0 to 1 weight-%, preferably from 0.001 to 0.1 weight-%, more preferably from 0.01 to 0.1 weight-%, of a crystalline phase NiAl₂O₄, wherein the mixed oxide more preferably is essentially free of a crystalline phase NiAl₂O₄, wherein the mixed oxide more preferably does not comprise a crystalline phase NiAl₂O₄.
61. The molding of any one of embodiments 47 to 60, wherein the mixed oxide comprises from 0 to 1 weight-%, preferably from 0.001 to 0.1 weight-%, more preferably from 0.01 to 0.1 weight-%, of a crystalline phase NiO, wherein the mixed oxide more preferably is essentially free of a crystalline phase NiO, wherein the mixed oxide more preferably does not comprise a crystalline phase NiO.
62. The molding of any one of embodiments 47 to 61, wherein the mixed oxide comprises from 0 to 1 weight-%, preferably from 0.001 to 0.1 weight-%, more preferably from 0.01 to 0.1 weight-%, of a crystalline phase MgO, wherein the mixed oxide more preferably is essentially free of a crystalline phase MgO, wherein the mixed oxide more preferably does not comprise a crystalline phase MgO.
63. The molding of any one of embodiments 47 to 62, wherein the molding comprises from 0 to 1 weight-%, preferably from 0.001 to 0.1 weight-%, more preferably from 0.01 to 0.1 weight-%, of a crystalline phase Al₂O₃, wherein the molding more preferably is essentially free of a crystalline phase Al₂O₃, wherein the molding more preferably does not comprise a crystalline phase Al₂O₃.
64. The molding of any one of embodiments 47 to 63, wherein the molding comprises from 0 to 1 weight-%, preferably from 0.001 to 0.1 weight-%, more preferably from 0.01 to 0.1 weight-%, of a crystalline phase NiAl₂O₄, wherein the molding more preferably is essentially free of a crystalline phase NiAl₂O₄, wherein the molding more preferably does not comprise a crystalline phase NiAl₂O₄.
65. The molding of any one of embodiments 47 to 64, wherein the molding comprises from 0 to 1 weight-%, preferably from 0.001 to 0.1 weight-%, more preferably from 0.01 to 0.1 weight-%, of a crystalline phase NiO, wherein the molding more preferably is essentially free of a crystalline phase NiO, wherein the molding more preferably does not comprise a crystalline phase NiO.
66. The molding of any one of embodiments 47 to 65, wherein the molding comprises from 0 to 1 weight-%, preferably from 0.001 to 0.1 weight-%, more preferably from 0.01 to 0.1 weight-%, of a crystalline phase MgO, wherein the molding more preferably is essentially free of a crystalline phase MgO, wherein the molding more preferably does not comprise a crystalline phase MgO.
67. The molding of any one of embodiments 47 to 66, wherein from 99 to 100 weight-%, preferably from 99.5 to 100 weight-%, more preferably from 99.9 to 100 weight-% of the mixed oxide consist of O, Mg, Ni, optionally a metal M as defined in any one of embodiments 53 to 58, and optionally H.
68. The molding of any one of embodiments 47 to 67, wherein the mixed oxide comprises the crystalline phase NiₓMg_{y}O, in an amount in the range of from 1 to 50 weight-%, preferably in the range of from 5 to 40 weight-%, more preferably in the range of from 10 to 30 weight-%, based on the total weight of the mixed oxide.
69. The molding of any one of embodiments 47 to 68, wherein the mixed oxide comprises a crystalline phase NiₐMg_{b}O, in an amount of equal to or less than 20 weight-%, preferably equal to or less than 15 weight-%, more preferably equal to or less than 10 weight-%, based on the total weight of the mixed oxide.
70. The molding of any one of embodiments 47 to 69, wherein the lattice parameter a of the crystalline phase NiₓMg_{y}O is in the range of from 4.18 to 4.22 Angstrom, preferably in the range of from 4.190 to 4.204, more preferably in the range of from 4.1940 to 4.1997, wherein the lattice parameter a is preferably determined according to Reference Example 2.
71. The molding of any one of embodiments 47 to 70, wherein the mixed oxide exhibits a X-ray diffraction spectrum, determined as described in Reference Example 2, wherein the X-ray diffraction spectrum comprises a first peak having a maximum in the range of from 43.00 to 43.30° 2theta, wherein d according to the Bragg equation preferably is in the range of from 2.08 to 2.10 Angstrom, and a second peak having a maximum in the range of from 44.63 to 45.03° 2theta, wherein d preferably is in the range of from 2.01 to 2.03

Angstrom.
72. The molding of embodiment 71, wherein the intensity of the maximum of the first peak, calculated as peak height in arbitrary units, is equal to or less than the intensity of the maximum of the second peak, calculated as peak height in arbitrary units, wherein the ratio of the intensity of the maximum of the first peak to the intensity of the maximum of the second peak is in the range of from 0.3:1 to 1:1, preferably in the range of from 0.5:1 to 0.99:1, more preferably in the range of from 0.6:1 to 0.97:1, more preferably in the range of from 0.7:1 to 0.92:1.
73. The molding of any one of embodiments 47 to 72, comprising carbon, preferably equal to or less than 5 g per kg of the molding, more preferably equal to or less than 3 g per kg, more preferably equal to or less than 2 g per kg.
74. The molding of any one of embodiments 47 to 73, wherein the mixed oxide exhibits a temperature programmed reduction profile, wherein the temperature programmed reduction profile comprises a first peak having a maximum in the range of from 700 to 840° C., preferably in the range of from 750 to 825° C., wherein the temperature programmed reduction profile preferably is determined according to Reference Example 3.
75. The molding of any one of embodiments 47 to 74, wherein the mixed oxide exhibits a temperature programmed reduction profile, wherein the temperature programmed reduction profile comprises a second peak having a maximum in the range of from 850 to 900° C., preferably in the range of from 855 to 880° C., wherein the temperature programmed reduction profile preferably is determined according to Reference Example 3.
76. The molding of any one of embodiments 47 to 75, wherein the mixed oxide exhibits a temperature programmed reduction profile, wherein the temperature programmed reduction profile comprises a third peak having a maximum in the range of from 300 to 600° C., preferably in the range of from 350 to 550° C., wherein the temperature programmed reduction profile preferably is determined according to Reference Example 3.
77. The molding of any one of embodiments 47 to 76, wherein the mixed oxide exhibits a temperature programmed reduction profile, wherein the temperature programmed reduction profile shows a total hydrogen consumption in the range of from 10 to 1000 micromol H₂/g mixed oxide, preferably in the range of from 30 to 800 micromol H₂/g mixed oxide, more preferably in the range of from 50 to 700 micromol H₂/g mixed oxide, at a temperature below 600° C., preferably in the range of from 0 to 600° C., more preferably in the range of from 50 to 600° C., wherein the temperature programmed reduction profile preferably is determined according to Reference Example 3.
78. The molding of any one of embodiments 47 to 77, wherein the mixed oxide exhibits a temperature programmed reduction profile, wherein the temperature programmed reduction profile shows a total hydrogen consumption in the range of from 1300 to 3000 micromol H₂/g mixed oxide, preferably in the range of from 1500 to 2800 micromol H₂/g mixed oxide, more preferably in the range of from 1700 to 2600 micromol H₂/g mixed oxide, at a temperature above 600° C., preferably in the range of from 600 to 1000° C., more preferably in the range of from 600 to 950° C., wherein the temperature programmed reduction profile preferably is determined according to Reference Example 3.
79. The molding of any one of embodiments 47 to 78, wherein from 99 to 100 weight-%, preferably from 99.5 to 100 weight-%, more preferably from 99.9 to 100 weight-% of the molding consist of the mixed oxide.
80. The molding of any one of embodiments 47 to 79, wherein the molding is not calcined.
81. The molding of any one of embodiments 47 to 80, being a tablet, preferably being a tablet having a four-hole cross-section, more preferably being a tablet having a four-hole cross-section and having four flutes, more preferably being a tablet having a four-hole cross-section having a diameter in the range of from 13 to 19 mm, more preferably in the range of from 14 to 18 mm, more preferably in the range of from 15 to 17 mm, and a height in the range of from 9 to 11 mm, more preferably in the range of from 9.5 to 10.5 mm, more preferably in the range of from 9.7 to 10 mm.
82. A process for preparing a re-shaped molding, preferably for preparing a re-shaped molding of the molding comprising a mixed oxide according to any one of embodiments 46 to 81, wherein the process comprises
   (a) preferably calcining a molding obtained from (iii) of a process according to any one of embodiments 1 to 45, in a gas atmosphere having a temperature in the range of from 350 to 550° C., preferably in the range of from 400 to 500° C., more preferably in the range of from 425 to 475° C.;
   (b) more preferably crushing the molding obtained from (a) to particles having an average particle size in the range of from 0.1 to 0.9 mm, preferably in the range of from 0.2 to 0.8 mm, determined according to Reference Example 2;
   (c) more preferably preparing a mixture comprising one or more binders and the molding obtained from (b);
   (d) subjecting a molding obtained from (iii) of a process according to any one of embodiments 1 to 45, preferably the calcined molding obtained from (a), more preferably the molding obtained from (b), more preferably the molding obtained from (c), to a re-shaping process;
   (e) calcining the molding obtained from (d) in a gas atmosphere having a temperature in the range of from 800 to 1300° C., obtaining a re-shaped molding.
83. The process of embodiment 82, wherein the re-shaped molding obtained from (e) has a shape different to the shape of the molding obtained from (iii).
84. The process of embodiment 82 or 83, wherein the gas atmosphere in (e) has a temperature in the range of from 850 to 1150° C., preferably in the range of from 900 to 1100° C., more preferably in the range of from 950 to 1050° C.
85. The process of any one of embodiments 82 to 84, wherein the gas atmosphere in (e) comprises oxygen and optionally nitrogen, wherein the gas atmosphere preferably is air or lean air.
86. The process of any one of embodiments 82 to 85, wherein the calcination in (e) is performed for 0.1 to 5 h, preferably for 0.5 to 3 h, more preferably for 0.75 to 1.5 h, more preferably for 0.9 to 1.1 h.
87. The process of any one of embodiments 82 to 85, wherein the calcination in (e) is performed for 1 to 10 h, preferably for 3 to 5 h, more preferably for 3.5 to 4.5 h, more preferably for 3.9 to 4.1 h.
88. The process of any one of embodiments 82 to 87, wherein the gas atmosphere in (a) comprises oxygen and optionally nitrogen, wherein the gas atmosphere preferably is air or lean air.
89. The process of any one of embodiments 82 to 88, wherein crushing according to (b) comprises, preferably consists of, milling.
90. The process of any one of embodiments 82 to 89, wherein subjecting a molding obtained from (iii), preferably the molding obtained from (a), more preferably the molding obtained from (b), more preferably the molding obtained from (c), to a re-shaping process in (d) comprises, preferably consists of, extruding or tableting, preferably tableting.
91. The process of any one of embodiments 82 to 90, wherein subjecting a molding obtained from (iii), preferably the molding obtained from (a), more preferably the molding obtained from (b), more preferably the molding obtained from (c), to a re-shaping process in (d) comprises, preferably consists of, tableting the molding to tablets having a cylindrical shape.
92. The process of embodiment 91, wherein the tablets having a cylindrical shape have a diameter in the range of from 10 to 22 mm, preferably in the range of from 14 to 19 mm, more preferably in the range of from 16 to 17 mm.
93. The process of embodiment 91 or 92, wherein the tablets having a cylindrical shape have a height in the range of from 5 to 15 mm, preferably in the range of from 8 to 12 mm, more preferably in the range of from 9 to 11 mm.
94. The process of any one of embodiments 82 to 93, wherein in the mixture prepared in (c), the weight of the one or more binders calculated with respect to the total weight of the mixture is in the range of from 0.5 to 10 weight-%, more preferably in the range of from 1 to 9 weight-%, more preferably in the range of from 2 to 4 weight-%.
95. The process of any one of embodiments 82 to 94, wherein the one or more binders in (c) comprise one or more of graphite, a polysaccharide, a sugar alcohol and a synthetic polymer, preferably one or more of graphite and a polysaccharide.
96. The process of embodiment 95, wherein the polysaccharide is one or more of cellulose, a modified cellulose and a starch, wherein the cellulose preferably is a microcrystalline cellulose, wherein the modified cellulose preferably is one or more of a cellulose ether, a hydroxypropyl cellulose (HCP) and a hydroxypropyl methylcellulose (HPMC).
97. The process of embodiment 95 or 96, wherein the sugar alcohol is one or more of sorbitol and mannitol.
98. The process of any one of embodiments 95 to 97, wherein the synthetic polymer is one or more of polyethylene glycol (PEG) and polyvinylpyrrolidone (PVP).
99. A re-shaped molding comprising a mixed oxide comprising O, Mg, and Ni, obtainable or obtained by a process according to any one of embodiments 82 to 98.
100. Use of a molding according to any one of embodiments 46 to 81 or of a re-shaped molding according to embodiment 99 as a catalytically active material, as a catalyst component or as a catalyst, preferably for reforming one or more hydrocarbons, wherein the hydrocarbons are preferably selected from the group consisting of methane, ethane, propane, butane, and a mixture of two or more thereof, wherein the hydrocarbons are more preferably methane, to a synthesis gas comprising hydrogen and carbon monoxide, preferably in the presence of one or more of carbon dioxide and steam.
101. A method for reforming one or more hydrocarbons, preferably for reforming methane, to a synthesis gas comprising hydrogen and carbon monoxide, the method comprising
   (a) providing a reactor comprising a reaction zone which comprises the molding of any one of embodiments 46 to 81 or of a re-shaped molding according to embodiment 99;
   (b) passing a reactant gas stream into the reaction zone obtained from (a), wherein the reactant gas stream passed into the reaction zone comprises the one or more hydrocarbons, carbon dioxide, and water; subjecting said reactant gas stream to reforming conditions in said reaction zone; and removing a product stream from said reaction zone, said product stream comprising hydrogen and carbon monoxide.

The present invention is further illustrated by the following Examples and Reference Examples.

### EXAMPLES

### Reference Example 1: Determination of the BET Specific Surface Area and the Langmuir Specific Surface Area

The BET specific surface area and the Langmuir specific surface area were determined via nitrogen physisorption at 77 K according to the method disclosed in DIN 66131.

### Reference Example 2: Determination of Crystallinity Via XRD

The sample is ground using a mill until it is a fine powder. The mill used is a “Tube Mill” manufactured by IKA-Werke GmbH & CO. KG. After that the samples are transferred to a standard sample holder (material PMMA, manufacturer Bruker AXS) and flattened using a glass plate. The samples are measured in a D8 Advance diffractometer (Bruker AXS) using variable slits set to a constant angle of 0.3° and an area detector (LYNXEYE, Bruker AXS) in an angular range of 10°-80° 2theta with a step size of 0.02° 2theta.

The data analysis is performed using the software TOPAS 6 (see TOPAS Users Manual of Nov. 22, 2017). The modelled phase composition is set to: MgAl₂O₄ and MgO:Ni. The structure published in Acta Crystallographica (see Acta Crystallographica 1952, 5, 684-686) was used to model the MgAl₂O₄ Spinell. The structure published in Zeitschrift für Kristallograhie—Crystalline Materials (see Z. Kristallogr. 1921, 56, 430) was used as a basis for the model of MgO:Ni. The occupation of the Ni doping was refined by using Vegard's law (see Zeitschrift für Physik 1921, 5, 1, 17-26; doi:10.1007/BF01349680) of the linear correlation between the mixed elemental occupation of crystallographic site with the lattice parameters. It was determined that the occupation of Ni takes the following value in dependance on the lattice parameter (a) of MgO:Ni

Nickel occupation=(4.2122 Angstrom−α)/0.0343

In all phases the lattice parameters are refined. The crystallite size is refined assuming a lorenzian profile contribution, in addition the Gaussian strain component is refined for phase MgO:Ni. The background is modelled using a 2nd order Polynomial. Sample height is also refined. Intensity corrections for Lorentz and polarization effects are considered. The reported crystallite size is that given out by TOPAS in the field “Lvol FWHM”.

### Reference Example 3: Determination of Temperature Programmed Reduction (TPR) Profile

The reduction behavior of a molding was determined by temperature programmed reduction. 200 mg of a sample having particles with an average particle size between 0.2 and 0.4 mm were used. As a feed gas a stream of 5 volume-% hydrogen in Argon was used, whereby the feed rate was set to 50 ml/min. The temperature was increased during a measurement from room temperature up to 950° C. with a heating rate of 5 K/min. The thermal conductivity detector (TCD) signal was recorded relative to the temperature to give the TPR profile. The TPR profiles of Examples 1-6, and Comparative Examples 1 are shown in FIGS. 2 and 3. The maxima in the recorded data related to the hydrogen consumption of a sample indicating reduction of Nickel.

### Example 1: Preparation of a Molding Comprising a Mg-Rich Crystalline Phase NiₓMg_{y}O

200 g of an aluminum magnesium hydroxyl carbonate (Mg₂ₓAl₂(OH)₄ₓ₊₄CO₃.n H₂O; Pural MG30; Sasol; lot number 11115) and 52.7 g nickel(II)carbonate (CAS 12607-70-4; containing 47.8 weight-% of Ni; Sigma-Aldrich) were mixed for several minutes in a kneader (alternatively in a mixer). Then 200 ml of an aqueous solution of formic acid in deionized water (50 weight-% of formic acid in water, the aqueous solution having a density of 1.1207 kg/I at 20° C.) and 50 ml of deionized water were added within 10 min. Under further mixing during 10 min a dough-like homogeneous mass was formed. The obtained mass was then extruded to strands with 3.5 mm in diameter. Then, the extrudates were dried at 120° C. for 16 hours. Subsequently, the dried extrudates were calcined in an annealing furnace under air at 950° C. for 4 hours.

The nickel content of the calcined moldings was 15.3 weight-%, the magnesium content 13.1 weight-% and the aluminum content 29.1 weight-%, calculated as the elements, respectively. The calcined moldings comprised 81 weight-% of a crystalline phase MgAl₂O₄ having an average particle size of 12 nm and 19 weight-% of a crystalline phase NiₓMg_{y}O, whereby x was 0.34 and y was 0.66, having an average particle size of 15 nm. The lattice parameter a of the NiₓMg_{y}O phase was determined as being 4.1997. In the TPR profile, a first peak was found having a maximum at about 775° C. and a second peak having a maximum at about 875° C. Further, the resulting product showed a total hydrogen consumption in the TPR profile below 600° C. of 69 micromol H₂/g product, and above 600° C. of 2141 micromol H₂/g product.

### Example 2: Preparation of a Molding Comprising a Mg-Rich Crystalline Phase NiₓMg_{y}O

In accordance with Example 1 a molding was prepared, whereby a different nickel source was used. Nickel(II)carbonate as the nickel source was prepared by precipitating nickel(II)carbonate from a nickel nitrate solution. In particular, 1000 g of deionized water were placed in a 10 l beaker and heated to a temperature of 80° C. 2274 g of an aqueous nickel nitrate solution (13.2 weight-% nickel content, density of 1.514 kg/I) was provided separately and heated up to a temperature of 80° C. Further, 3776.5 g of an aqueous sodium carbonate solution (20 weight-% Na₂CO₃ in water) was provided separately and heated up to a temperature of 80° C. The aqueous nickel nitrate solution and the aqueous sodium carbonate solution were added to the deionized water in the beaker, whereby the pH was kept between 7 and 8. The resulting solids were filtered off and washed with about 169 l deionized water. The resulting solids were dried at 105 h for 16 h to yield 572 g of nickel carbonate.

The nickel content of the calcined moldings was 16.3 weight-%, the magnesium content 12.8 weight-% and the aluminum content 28.1 weight-%, calculated as the elements, respectively. The calcined moldings comprised 74 weight-% of a crystalline phase MgAl₂O₄ having an average particle size of 9 nm and 26 weight-% of a crystalline phase NiₓMg_{y}O, whereby x was 0.46 and y was 0.54 having an average particle size of 21.5 nm. The lattice parameter a of the NiₓMg_{y}O phase was determined as being 4.1954. In the TPR profile, a first peak was found having a maximum at about 800° C., a second peak having a maximum at about 860° C., and a third peak having a maximum at about 450° C. Further, the resulting product showed a total hydrogen consumption in the TPR profile below 600° C. of 144 micromol H₂/g product, and above 600° C. of 2565 micromol H₂/g product.

### Example 3: Preparation of a Molding Comprising a Mg-Rich Crystalline Phase NiₓMg_{y}O

In accordance with Example 1 a molding was prepared, whereby a different acid was used. As an acid nitric acid was used instead of formic acid, whereby an amount of nitric acid was used in Example 3 such that the molar ratio of acid used to Ni, calculated as elemental Ni, was 0.6:1. Further, the nickel source was first mixed with the acid and water, and subsequently mixed with the aluminum magnesium hydroxyl carbonate.

The nickel content of the calcined moldings was 15.1 weight-%, the magnesium content 12.7 weight-% and the aluminum content 28.7 weight-%, calculated as the elements, respectively. The calcined moldings comprised 73 weight-% of a crystalline phase MgAl₂O₄ having an average particle size of 8 nm, 8 weight-% of a crystalline phase NiₐMg_{b}O, whereby a was 0.78 and b was 0.22, having an average particle size of 44 nm and 19 weight-% of a crystalline phase NiₓMg_{y}O, whereby x was 0.46 and y was 0.54, having an average particle size of 3.5 nm. The lattice parameter a of the crystalline phase NiₐMg_{b}O was determined as being 4.1844, and the lattice parameter a of the crystalline phase NiₓMg_{y}O was determined as being 4.1956. In the TPR profile, a first peak was found having a maximum at about 775° C., a second peak having a maximum at about 875° C., and a third peak having a maximum at about 500° C. Further, the resulting product showed a total hydrogen consumption in the TPR profile below 600° C. of 634 micromol H₂/g product, and above 600° C. of 1710 micromol H₂/g product.

### Example 4: Preparation of a Molding Comprising a Mg-Rich Crystalline Phase NiₓMg_{y}O

In accordance with Example 1 a molding was prepared, whereby a different acid and a different nickel source was used. As an acid nitric acid was used instead of formic acid, whereby an amount of nitric acid was used in Example 4 such that the molar ratio of acid to Ni was 0.004:1. Further, a portion of the nickel(II)carbonate as used in Example 1 was replaced by an aqueous nickel nitrate solution having a nickel concentration of 13.2 weight-% such that 70 weight-% of the nickel source was in the form of nickel(II)carbonate and 30 weight-% of the nickel source was nickel nitrate. Further, the nickel nitrate solution was first mixed with the acid, and subsequently mixed with the aluminum magnesium hydroxyl carbonate.

The nickel content of the calcined moldings was 15.2 weight-%, the magnesium content 12.9 weight-% and the aluminum content 28.7 weight-%, calculated as the elements, respectively. The calcined moldings comprised 74 weight-% of a crystalline phase MgAl₂O₄ having an average particle size of 8.5 nm, 5 weight-% of a crystalline phase NiₐMg_{b}O, whereby a was 0.81 and b was 0.19, having an average particle size of 62 nm and 21 weight-% of a crystalline phase NiₓMg_{y}O, whereby x was 0.41 and y was 0.59, having an average particle size of 4.5 nm. The lattice parameter a of the crystalline phase NiₐMg_{b}O was determined as being 4.1835, and the lattice parameter a of the crystalline phase NiₓMg_{y}O was determined as being 4.1972. In the TPR profile, a first peak was found having a maximum at about 800° C., a second peak having a maximum at about 875° C., and a third peak having a maximum at about 475° C. Further, the resulting product showed a total hydrogen consumption in the TPR profile below 600° C. of 411 micromol H₂/g product, and above 600° C. of 1916 micromol H₂/g product.

### Example 5: Preparation of a Molding Comprising a Mg-Rich Crystalline Phase NiₓMg_{y}O

In accordance with Example 1 a molding was prepared, whereby a different acid and a different nickel source was used. As an acid nitric acid was used instead of formic acid, whereby an amount of nitric acid was used in Example 4 such that the molar ratio of acid to Ni was 0.007:1. Further, a portion of the nickel(II)carbonate as used in Example 1 was replaced by an aqueous nickel nitrate solution having a nickel concentration of 13.2 weight-% such that 50 weight-% of the nickel source was in the form of nickel(II)carbonate and 50 weight-% of the nickel source was nickel nitrate. Further, the nickel nitrate solution was first mixed with the acid, and subsequently mixed with the aluminum magnesium hydroxyl carbonate.

In the TPR profile, a first peak was found having a maximum at about 775° C., a second peak having a maximum at about 875° C., and a third peak having a maximum at about 350° C. Further, the resulting product showed a total hydrogen consumption in the TPR profile below 600° C. of 302 micromol H₂/g product, and above 600° C. of 1713 micromol H₂/g product.

### Example 6: Preparation of a Molding Comprising a Mg-Rich Crystalline Phase NiₓMg_{y}O

In accordance with Example 1 a molding was prepared, whereby a different acid and a different nickel source was used. As an acid nitric acid was used instead of formic acid, whereby an amount of nitric acid was used in Example 4 such that the molar ratio of acid to Ni was 0.01:1. Further, a portion of the nickel(II)carbonate as used in Example 1 was replaced by an aqueous nickel nitrate solution having a nickel concentration of 13.2 weight-% such that 30 weight-% of the nickel source was in the form of nickel(II)carbonate and 70 weight-% of the nickel source was nickel nitrate. Further, the nickel nitrate solution was first mixed with the acid, and subsequently mixed with the aluminum magnesium hydroxyl carbonate.

In the TPR profile, a first peak was found having a maximum at about 750° C., a second peak having a maximum at about 875° C., and a third peak having a maximum at about 350° C. Further, the resulting product showed a total hydrogen consumption in the TPR profile below 600° C. of 152 micromol H₂/g product, and above 600° C. of 1869 micromol H₂/g product.

### Comparative Example 1: Preparation of a Molding According to the Prior Art

Example E1 of WO 2013/068905 A1 was repeated.

The nickel content of the calcined moldings was 14.7 weight-%, the magnesium content 14.2 weight-% and the aluminum content 30.0 weight-%, calculated as the elements, respectively.

The calcined moldings comprised 79 weight-% of a crystalline phase MgAl₂O₄ having an average particle size of 8 nm and 21 weight-% of a crystalline phase NiₐMg_{b}O, whereby a was 0.52 and b was 0.48, having an average particle size of 5.5 nm. The lattice parameter a of the crystalline phase NiₐMg_{b}O was determined as being 4.1933. In the TPR profile, a single peak was found having a maximum at about 775° C. Further, the resulting product showed a total hydrogen consumption in the TPR profile below 600° C. of 0 micromol H₂/g catalyst, and above 600° C. of 2018 micromol H₂/g catalyst.

### Comparative Example 2: Preparation of a Molding without Use of an Acid

In accordance with Example 1 a molding was prepared, whereby no acid was used. The respective amount of formic acid used in Example 1 was thus replaced by an equivalent mass of deionized water.

The nickel content of the calcined moldings was 15.0 weight-%, the magnesium content 12.8 weight-% and the aluminum content 28.9 weight-%, calculated as the elements, respectively. The calcined moldings comprised 75 weight-% of a crystalline phase MgAl₂O₄ having an average particle size of 8 nm, 7 weight-% of a crystalline phase NiₐMg_{b}O, whereby a was 0.91 and b was 0.09, having an average particle size of 101 nm and 18 weight-% of a crystalline phase NiₓMg_{y}O, whereby x was 0.56 and y was 0.44, having an average particle size of 12 nm. The lattice parameter a of the crystalline phase NiₐMg_{b}O was determined as being 4.1810, and the lattice parameter a of the crystalline phase NiₓMg_{y}O was determined as being 4.1983. In the TPR profile, a first peak was found having a maximum at about 775° C., a second peak having a maximum at about 375° C. and a third peak having a maximum at about 450° C. Further, the resulting product showed a total hydrogen consumption in the TPR profile below 600° C. of 1080 micromol H₂/g product, and above 600° C. of 1271 micromol H₂/g product.

### Example 7: Catalytic Testing

Catalytic tests were performed on a single reactor test unit. This unit allowed for test conditions in a broad temperature and pressure regime up to 1100° C. and 20 bar (gauge). As gas feeds carbon dioxide (also designated as carbon dioxide-in or CO₂-in), methane (also designated as methane-in or CH₄-in), hydrogen (also designated as hydrogen-in), nitrogen (also designated as nitrogen-in) and argon (also designated as argon-in) were provided and online controlled by mass flow controllers (M FCs). Water was added as steam to the feed stream by an evaporator connected to a water reservoir. Analysis of the product gas composition was carried out by online-gas chromatography using argon as internal standard. Gas chromatographic analytics allowed the quantification of hydrogen, carbon monoxide, carbon dioxide (also designated as CO₂-out), methane (also designated as CH₄-out) and C₂ components. Duration of the gas chromatographic method was set to 24 min. For the catalytic test, the prepared molding was split (0.5 to 1.0 mm) and 15 ml of the split were then tested as a catalyst. The sample was placed in the isothermal zone of the reactor using a ceramic fitting. Prior to the start of the experiment the back pressure was determined. The catalyst was tested according to a standard test protocol according to Table 3.

TABLE 3
Test protocol used for catalytic testing. In each
phase the pressure was adjusted to 20 bar (gauge)

| | | | | | | | Equilibrium | Equilibrium |
|---|---|---|---|---|---|---|---|---|
| | | | Methane- | CO₂-in | Steam- | Nitrogen- | for CH₄- | for CO₂- |
| Phase | T | GHSV | in | [mol. - | in | in | conversion | conversion |
| [#] | [° C.] | [h⁻¹] | [mol.-%] | %] | [mol.-%] | [mol.-%] | [mol-%] | [mol-%] |
| 1.1 | 900 | 8000 | 47.5 | 0 | 47.5 | 5.0 | 63 | — |
| 2.1 | 900 | 8000 | 27.5 | 27.5 | 40.0 | 5.0 | 88 | 48 |
| 3 | 900 | 8000 | 38.0 | 19.0 | 38.0 | 5.0 | 76 | 56 |
| 4 | 950 | 4000 | 47.5 | 0 | 47.5 | 5.0 | 84 | — |
| 5 | 950 | 8000 | 47.5 | 0 | 47.50 | 5.0 | 84 | — |
| 6 | 950 | 8000 | 27.5 | 27.5 | 40.0 | 5.0 | 94 | 53 |
| 7 | 950 | 8000 | 38.0 | 19.0 | 38.0 | 5.0 | 85 | 65 |
| 1.2 | 900 | 8000 | 47.5 | 0 | 47.5 | 5.0 | 63 | — |
| 2.2 | 900 | 8000 | 27.5 | 27.5 | 40.0 | 5.0 | 88 | 48 |

GHSV: gas hourly space velocity

Based on the quantification of the product gas stream the methane conversion [1], carbon dioxide conversion [2], hydrogen/carbon monoxide ratio as well as the product gas composition and C₂-components fraction were calculated:

Methane conversion: X(CH₄)=1-(CH₄-out/CH₄-in) [1]

Carbon dioxide conversion: X(CO₂)=1-(CO₂-out/CO₂-in) [2]

In addition, the relative conversions of methane [3] and carbon dioxide [4] were calculated and represent the conversions related to the thermodynamic maximum conversions X_max (equilibrium composition). The equilibrium composition was calculated taking the test conditions accordingly into account:

Methane-relative conversion: X_rel(CH₄)═X(CH₄)/X_max(CH₄) [3]

Carbon dioxide-relative conversion: X_rel(CO₂)═X(CO₂)/X_max(CO₂) [4]

In order to determine the catalytic performance of the testes samples, for each sample the deviation from equilibrium for CH₄-conversion ΔX(CH₄) was determined as well as the deviation from equilibrium for CO₂-conversion ΔX(CO₂). Based on said results, total deviation was determined as the sum of the deviation from the equilibrium for the CH₄-conversion and the deviation from the equilibrium for the CO₂-conversion. The results are shown in tables 4 to 6 below. The deviation from equilibrium for CH₄-conversion ΔX(CH₄) was calculated according to [5] and the deviation from equilibrium for CO₂-conversion ΔX(CO₂) was calculated according to [6]:

ΔX(CH₄)═X(CH₄)^{eq}-X(CH₄)^{exp} [5]

ΔX(CO₂)═X(CO₂)^{eq}—X(CO₂)^{exp} [6]

The total deviation was calculated according to [7]:

Σ(ΔX)=|ΔX(CH₄)|+|ΔX(CO₂)|

TABLE 4
Deviation from equilibrium for CH₄-conversion ΔX(CH₄) in vol-%

| | Test phase | | | | | | | | | |
|---|---|---|---|---|---|---|---|---|---|---|
| Sample | 1.1 | 2.1 | 3 | 4 | 5 | 6 | 7 | 1.2 | 2.2 | Sum |
| Example 1 | 1 | 1 | 2 | 0.7 | 15 | 5 | 3 | 4 | 4 | 35 |
| Example 2 | 8 | 1 | 3 | 11 | 13 | 3 | 2 | 2 | 2 | 45 |
| Example 3 | 8 | 0 | 1 | 11 | 12 | 3 | 1 | 1 | 1 | 38 |
| Example 4 | 7 | −1 | 0 | 8 | 10 | 4 | 1 | 0 | 18 | 48 |
| Comp. Example 1 | 20 | 5 | 11 | 12 | 13 | 0 | 1 | 11 | 0 | 74 |
| Comp. Example 2 | 8 | 3 | 5 | 15 | 19 | 2 | 5 | 7 | 3 | 68 |

TABLE 5
Deviation from equilibrium for CO₂-conversion ΔX(CO₂) in vol-%

| | Test phase | | | | | | | | | |
|---|---|---|---|---|---|---|---|---|---|---|
| Sample | 1.1 | 2.1 | 3 | 4 | 5 | 6 | 7 | 1.2 | 2.2 | Sum |
| Example 1 | — | −15 | −20 | 0 | 0 | −24 | −22 | 0 | −16 | −96 |
| Example 2 | — | −12 | −16 | 0 | 0 | −13 | −14 | 0 | −12 | −67 |
| Example 3 | — | −10 | −14 | 0 | 0 | −11 | −13 | 0 | −11 | −58 |
| Example 4 | — | −14 | −19 | 0 | 0 | −20 | −15 | 0 | −20 | −88 |
| Comp. Example 1 | — | −36 | −52 | 0 | 0 | −19 | −28 | 0 | 0 | −135 |
| Comp. Example 2 | — | −9 | −14 | 0 | 0 | −9 | −2 | 0 | −10 | −65 |

TABLE 6
Total deviation from combined equilibrium for CH₄-conversion
and equilibrium for CO₂-conversion, packed density of sample
in test reactor and average carbon content of spent sample

| | Packed density | | Total deviation | Average |
|---|---|---|---|---|
| | of sample in | Time on | from combined | carbon content |
| | test reactor | stream | equilibrium | of spent sample |
| Sample | [g/ml] | [h] | Σ (ΔX) | [weight-%] |
| Example 1 | 0.71 | 240 | 153 | 0.2 |
| Example 2 | 0.65 | 222 | 112 | 0.38 |
| Example 3 | 0.57 | 232 | 97 | 0.06 |
| Example 4 | 0.58 | 230 | 136 | 0.09 |
| Comp. | 0.84 | 220 | 209 | 0.15 |
| Example 1 | | | | |
| Comp. | 0.47 | 257 | 133 | 0.83 |
| Example 2 | | | | |

TABLE 7
Duration in h of the test phases for
the Examples and Comparative Examples

| | Test | | | | | | | | | |
|---|---|---|---|---|---|---|---|---|---|---|
| | phase | | | | | | | | | |
| Sample | 1.1 | 2.1 | 3 | 4 | 5 | 6 | 7 | 1.2 | 2.2 | Sum |
| Example 1 | 18 | 12 | 18 | 70 | 26 | 24 | 24 | 24 | 24 | 240 |
| Example 2 | 22 | 24 | 24 | 47 | 22 | 25 | 23 | 23 | 12 | 222 |
| Example 3 | 18 | 24 | 24 | 71 | 6 | 17 | 24 | 24 | 24 | 232 |
| Example 4 | 24 | 22 | 24 | 49 | 22 | 24 | 21 | 20 | 24 | 230 |
| Comp. Example 1 | 20 | 12 | 20 | 65 | 7 | 23 | 25 | 24 | 24 | 220 |
| Comp. Example 2 | 23 | 22 | 23 | 69 | 24 | 24 | 27 | 24 | 21 | 257 |

In Example 1, the test phase 4 was conducted after test phase 7, such that the test sequence was 1.1, 1.2, 3, 5, 6, 7, 4, 1.2, 2.2.

As can be seen from the results shown in table 4 relative to the CH₄-conversion, all catalytic materials in accordance with the present invention showed superior overall performance. The catalytic material in accordance with Example 1 showed the best result considering the overall performance. Similarly, it can be seen from the results shown in table 5 that the catalytic materials in accordance with Examples 1˜4 showed superior performance in comparison to Comparative Example 1. The catalytic material in accordance with Example 3 showed the best result considering the overall performance. As can be gathered from table 6 catalytic materials according to examples 1˜4 were closer to the thermodynamic conversion than Comparative Example 1. Further, Examples 2-3 are closer to the thermodynamic conversion than Comparative Example 2. It has been further shown that Comparative Example 2 presented a significant amount of undesired carbon deposits (coking). In contrast thereto, Examples 1˜4 contained a comparatively low amount of carbon. Said results clearly indicate that the catalytic materials in accordance with the present invention show superior catalytic activity and longevity with regard to the conversion of methane and carbon dioxide in comparison to the catalytic materials of the prior art represented by Comparative Examples 1 and 2.

### DESCRIPTION OF THE FIGURES

FIG. 1: shows a conceptional view of a tablet having a four-hole cross-section and having four flutes. The height of a tablet is orthogonal to the shown cross-section.

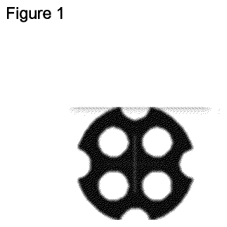

FIG. 2: shows the TPR profile for Examples 1 and 2, as well as for Comparative Example 1. The thermal conductivity detector (TCD) signal was recorded relative to the temperature to give the TPR profile. Thus, the TCD signal is given in arbitrary units on the ordinate and the temperature is shown on the abscissa in ° C. The dashed line relates to Example 1, the dotted line relates to Example 2, and the solid line relates to Comparative Example 1.

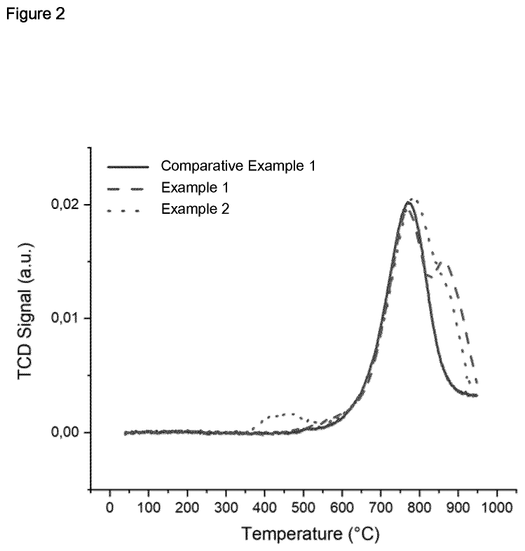

FIG. 3: shows the TPR profile for Examples 3, 4, 5 and 6, as well as for Comparative Example 1. The thermal conductivity detector (TCD) signal was recorded relative to the temperature to give the TPR profile. Thus, the TCD signal is given in arbitrary units on the ordinate and the temperature is shown on the abscissa in ° C. The dashed-dotted line relates to Example 3, the grey solid line relates to Example 4, the dashed line relates to Example 5, the dotted line relates to Example 6, and the black solid line relates to Comparative Example 1.

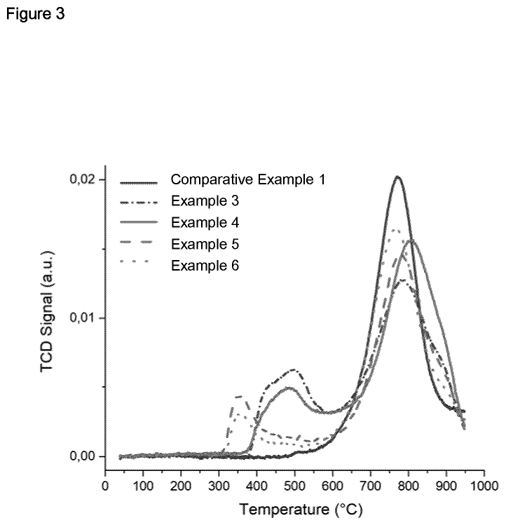

FIG. 4: shows the TPR profile for Comparative Examples 1 and 2. The thermal conductivity detector (TCD) signal was recorded relative to the temperature to give the TPR profile. Thus, the TCD signal is given in arbitrary units on the ordinate and the temperature is shown on the abscissa in ° C. The black solid line relates to Comparative Example 1, the dashed-dotted line relates to Comparative Example 2.

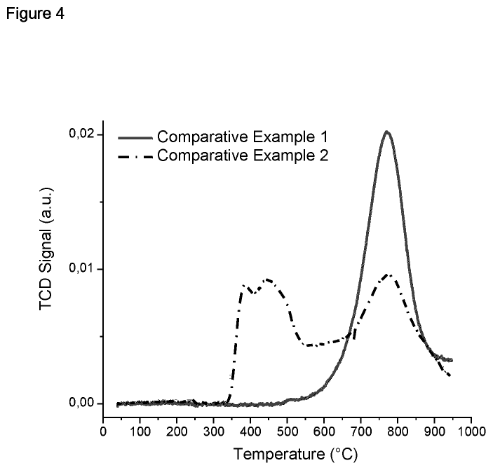

### CITED LITERATURE

WO 2013/068905 A1
WO 2013/118078 A1

1.-15. (canceled)

16. A process for preparing a molding comprising a mixed oxide comprising O, Mg, and Ni, the process comprising
(i) mixing water, a Mg source, a Ni source, and an acid, to obtain a mixture;
(ii) subjecting the mixture obtained from (i) to a shaping process, obtaining a molding comprising the mixed oxide;
(iii) calcining the molding obtained from (ii) in a gas atmosphere having a temperature in the range of from 700 to 1400° C.;
wherein the molar ratio of the acid used in (i) to Ni, calculated as elemental Ni, of the Ni source used in (i), acid:Ni, is equal to or higher than 0.001:1.

17. The process of claim 16, wherein the weight ratio of Ni, calculated as elemental Ni, of the Ni source used in (i), relative to Mg, calculated as elemental Mg, of the Mg source used in (i), Ni:Mg, is in the range of from 0.1:1 to 5:1.

18. The process of claim 16, wherein the Mg source comprises one or more of magnesium carbonate, magnesium chloride, magnesium citrate, magnesium hydroxide, magnesium oxide, hydrotalcite and aluminum magnesium hydroxy carbonate.

19. The process of claim 16, wherein the Ni source comprises one or more of elemental nickel, nickel carbonate, nickel nitrate, nickel formate, nickel acetate, nickel chloride, nickel hydroxide, nickel nitrite, and nickel oxide.

20. The process of claim 16, wherein the weight ratio of the sum of the weight of the Mg source used in (i) and the weight of the Ni source used in (i) to the sum of the weight of the acid used in (i) and the weight of the water used in (i), is in the range of from 0.1:1 to 1:0.1.

21. The process of claim 16, wherein in (i) a source of a metal M is further admixed, wherein M is selected from the group consisting of aluminum, gallium, indium, silicon, germanium, tin, titanium and zirconium.

22. The process of claim 16, wherein the acid used in (i) comprises one or more of an organic acid and an inorganic acid.

23. A molding comprising a mixed oxide comprising O, Mg, and Ni, obtained by the process according to claim 16.

24. A molding comprising a mixed oxide obtained by the process according to claim 16,
wherein the mixed oxide comprises O, Mg, and Ni,
wherein the mixed oxide comprises a crystalline phase NiₓMg_{y}O,
wherein the sum of x and y is 1, and wherein y is greater than 0.52.

25. The molding of claim 24, wherein the mixed oxide further comprises a crystalline phase NiₐMg_{b}O, wherein the sum of a and b is 1, and
wherein a is equal or greater than 0.70,
wherein x is not equal to a.

26. The molding of claim 24, wherein in the mixed oxide the molar ratio of nickel to magnesium, Ni:Mg, each calculated as elemental Ni and Mg respectively, is in the range of from 0.20:1 to 0.75:1.

27. A process for preparing a re-shaped molding, wherein the process comprises
(a) optionally calcining the molding obtained from (iii) of a process according to claim 16, in a gas atmosphere having a temperature in the range of from 350 to 550° C.;
(b) optionally crushing the molding obtained from (a) to particles having an average particle size in the range of from 0.1 to 0.9 mm, determined according to Reference Example 2;
(c) optionally preparing a mixture comprising one or more binders and the molding obtained from (b);
(d) subjecting a molding obtained from (iii) of a process according to claim 16, to a re-shaping process;
(e) calcining the molding obtained from (d) in a gas atmosphere having a temperature in the range of from 800 to 1300° C., obtaining a re-shaped molding.

28. A re-shaped molding comprising a mixed oxide comprising O, Mg, and Ni, obtained by the process of claim 27.

29. Use of a molding according to claim 23 as a catalytically active material, as a catalyst component or as a catalyst.

30. A method for reforming one or more hydrocarbons to a synthesis gas comprising hydrogen and carbon monoxide, the method comprising
(a) providing a reactor comprising a reaction zone which comprises the molding of claim 23;
(b) passing a reactant gas stream into the reaction zone obtained from (a), wherein the reactant gas stream passed into the reaction zone comprises the one or more hydrocarbons, carbon dioxide, and water; subjecting said reactant gas stream to reforming conditions in said reaction zone; and removing a product stream from said reaction zone, said product stream comprising hydrogen and carbon monoxide.
